(19) United States
(12) Patent Application Publication
(10) Pub. No.: US 2026/0064876 A1
(43) Pub. Date: Mar. 5, 2026

(54) STANDARDIZED ENTERPRISE DATA ARCHITECTURE FOR READ-OPTIMIZED INFORMATION ACCESS AND VECTORIZATION FOR LLMS

(71) Applicant: Oracle International Corporation, Redwood Shores, CA (US)

(72) Inventors: Siva Chinni, Austin, TX (US); Tanvi Mehta, Redwood City, CA (US); Harshavardhan Takle, Foster City, CA (US); Kavin Kumar Kuppusamy, Redwood City, CA (US); Debi Prasad Dash, Karnataka (IN)

(73) Assignee: Oracle International Corporation, Redwood Shores, CA (US)

(21) Appl. No.: 19/184,870

(22) Filed: Apr. 21, 2025

Related U.S. Application Data
(60) Provisional application No. 63/691,238, filed on Sep. 5, 2024.

(51) Int. Cl. G06F 21/62; G06F 16/21; G06F 16/2455; G06F 16/27

(52) U.S. Cl. CPC G06F 21/6227; G06F 16/219; G06F 16/2456; G06F 16/27

(57) ABSTRACT

Systems, methods, and computer-readable media are provided for providing access, via a read-optimized database service, to functionally oriented pre-built metadata based logical objects. Each logical object provides access to a set of resources defined by a logical schema relevant to a functional area. Each logical schema is determined based at least in part on a read-optimized, synchronized version of one or more underlying related database structures stored to a read-optimized database accessible via the logical schema using the read-optimized database service, with the logical schema being different than the database schema of the underlying database structures. Requests to the read-optimized database service from a consumer of a particular functional area are evaluated against a particular set of logical resources associated with the functional area and translated to map to relevant underlying database structures, thus eliminating the requirement for consumer to understand underlying complex database structures as well as to shield consumers from underlying database structure changes in the future. Further some of the key text data in reference logical objects can be vectorized for usage in LLM-RAG use cases for assisting in semantic/similarity search of user queries. An attribute defaulting configuration interface and process is also described.

### CROSS-REFERENCE TO RELATED APPLICATION(S)

This application claims the benefit of U.S. Provisional Patent Application No. 63/691,238, filed on Sep. 5, 2024. The entire disclosure of the aforementioned application is incorporated by reference herein in its entirety for all purposes.

### BACKGROUND

Database systems provide access to create, read, modify, or delete database structures that store data. Database systems manage access for database users using role-based access controls, and applications may access data stored in the database systems using a single role for all users or fine-grained roles for each user. If a user has direct access to create, read, modify, or delete a database structure, the user can perform operations that may disrupt operation of the application. If the user does not have direct access to create, read, modify, or delete a database structure, the user may be unable to perform useful functionality in a system that relies on data management. Moreover, frequent accesses to the database system to perform data management operations can interfere with other database users or applications attempting to manage data in the database system. Application developers make decisions to promote application functionality while mitigating risk to other users.

### BRIEF SUMMARY

A read-optimized data management service is provided for accessing objects along functional pathways or areas without exposing underlying database structures. In some embodiments, the read-optimized data management service is a standardized Enterprise data architecture for read-optimized information access and vectorization for LLMs.

In various embodiments, systems, methods, and computer-readable media are provided for providing access, via a read-optimized database service, to functionally oriented pre-built metadata based logical objects. Each logical object provides access to a set of resources defined by a logical schema relevant to a functional area. Each logical schema is determined based at least in part on a read-optimized, synchronized version of one or more underlying related database structures stored to a read-optimized database accessible via the logical schema using the read-optimized database service, with the logical schema being different than the database schema of the underlying database structures. Requests to the read-optimized database service from a consumer of a particular functional area are evaluated against a particular set of logical resources associated with the functional area and translated to map to relevant underlying database structures, thus eliminating the requirement for consumer to understand underlying complex database structures as well as to shield consumers from underlying database structure changes in the future. Further some of the key text data in reference logical objects can be vectorized for usage in LLM-RAG use cases for assisting in semantic/similarity search of user queries. An attribute defaulting configuration interface and process is also described.

In some embodiments, a computer-implemented method includes providing access, via a read-optimized database service, to functional pathways or areas. Each functional pathway or area provides access to a logical set of resources defined by a logical schema. Each logical resource of the logical set of resources is determined based at least in part on a read-optimized, synchronized version of one or more underlying database structures even though the logical schema is different than a database schema of the underlying database structures. Requests to the read-optimized database service from a consumer of a particular functional pathway or area are evaluated against a particular set of logical resources associated with the particular functional pathway or area without providing access to other logical sets of resources associated with other functional pathways or areas and without providing direct access to the underlying database structures themselves.

An attribute defaulting configuration interface and process is also described.

In one embodiment, a computer-implemented method includes managing a read-optimized database service that leverages a plurality of underlying database structures from one or more underlying database services. The computer-implemented method further includes providing access, via the read-optimized database service, to a plurality of functional areas. Each functional area provides access to a logical set of resources defined by a logical schema. Each logical resource of the logical set of resources is determined based at least in part on a read-optimized, synchronized version of one or more underlying database structures of the plurality of underlying database structures. The logical schema is different than a database schema of the plurality of underlying database structures. The computer-implemented method further includes receiving a request to read data. The request is associated with a consumer of a particular functional area of the plurality of functional areas and references one or more logical resources. The computer-implemented method further includes evaluating the request against a particular logical set of resources associated with the particular functional area without providing access to one or more other logical sets of resources associated with one or more other functional areas. Evaluating the request comprises executing the request against a particular read-optimized, synchronized version of one or more particular underlying database structures on which the particular logical set of resources is based. Executing the request includes executing a join operation not specified in the request as received. Providing a structured result set to the consumer based at least in part on the particular read-optimized, synchronized version of the one or more particular underlying database structures. The structured result set references the one or more logical resources of the particular logical set of resources associated with the particular functional area.

In another embodiment, a computer-implemented method includes managing a read-optimized database service that leverages a plurality of underlying database structures from one or more underlying database services. The computer-implemented method further includes providing access, via the read-optimized database service, to a plurality of functionally oriented pre-built metadata-based logical objects. The read-optimized database service provides access to a set of resources defined by a logical schema relevant to a functional area. Each logical schema is determined based at least in part on a read-optimized, synchronized version of one or more underlying related database structures on a read optimized database. The logical schema is different than the database schema of the underlying database structures. The computer-implemented method further includes receiving a request to read data. The request is associated with a consumer of a particular functional area of the plurality of functionally oriented metadata-based logical objects and references one or more logical objects. The computer-implemented method further includes evaluating the request against a particular logical set of objects associated with the particular functional area. Evaluating the request comprises executing the request against a particular read-optimized, synchronized version of one or more particular underlying database structures on which the particular logical set of objects are based. Executing the request includes executing one or more join or filter operations not specified in the request as received. The operations may include join operations, filter operations, or a combination thereof. The method further includes providing a structured result set to the consumer based at least in part on the particular read-optimized, synchronized version of the one or more particular underlying database structures. The structured result set references the one or more logical objects associated with the particular functional area.

In any of the aforementioned embodiments, the structured result set is provided as a JSON object.

In any of the aforementioned embodiments, the consumer prompts a large language model based at least in part on the logical schema, and the large language model generates the request based at least in part on the logical schema.

In any of the aforementioned embodiments, the computer-implemented method further includes vectorizing content of the particular logical set of resources or objects using an embedding model specific to the particular logical set of resources or objects. The structured result set is based at least in part on the vectorized content.

In any of the aforementioned embodiments, the computer-implemented method further includes, responsive to the request, determining one or more particular data items that include one or more missing values as of when the request was received. The one or more particular data items are of a particular type of data item. The computer-implemented method further includes accessing a user-specific setting for the particular type of data item to determine that the particular type of data item is to have the missing values predicted by a machine learning model. The computer-implemented method further includes, based at least in part on the user-specific setting, replacing at least one of the one or more missing values with a particular predicted value determined from the machine learning model. The computer-implemented method further includes returning the one or more particular data items as part of the structured result set as if the particular predicted value was part of the one or more particular data items when the request was received.

In one embodiment, a computer-implemented method includes causing display of a configuration interface that provides a first option for treating missing values of a particular type of data item and a second option for treating missing values of another particular type of data item. The computer-implemented method further includes receiving, via the configuration interface, a user-specific setting for a user that specifies the particular type of data item and not the other particular type of data item is to have the missing values predicted by a machine learning model. The computer-implemented method further includes training the machine learning model to predict values for at least one field of the particular type of data item. The machine learning model is trained on a plurality of historical instances of the particular type of data item where a value for the at least one field is not missing. The computer-implemented method further includes receiving a request to retrieve data for the user. The computer-implemented method further includes, responsive to the request, determining a result including one or more particular data items that include one or more missing values. The one or more particular data items are of the particular type of data item. Based at least in part on the user-specific setting, the computer-implemented method replaces at least one of the one or more missing values with a particular predicted value determined from the machine learning model. The computer-implemented method further includes returning the one or more particular data items as if the particular predicted value was part of the one or more particular data items when the request was received, optionally without updating the one or more particular data items as stored in an underlying database.

In some embodiments, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

As used herein, the terms “first,” “second,” “third,” “fourth,” etc. are used as naming conventions to refer to separate items in a set of items. These naming conventions do not imply ordering unless such ordering is explicitly noted using language specific to ordering, such as “before” or “after,” or unless such ordering is required to attain the expressly recited functionality, such as generating an item and later accessing the generated item.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1A illustrates a flow chart of an example process that uses a read-optimized data management service to access objects without exposing underlying database structures or other pathways.

FIG. 1B illustrates a flow chart of an example attribute defaulting configuration and process.

FIG. 2 illustrates a system diagram showing an example system that uses a read-optimized data management service to access logical objects without exposing underlying database structures.

FIG. 3 shows an example overall architecture.

FIG. 4 shows an example object modeling approach on a Read-Optimized Data Service (RODS).

FIG. 5 shows object model examples on RODS, with examples of physical, logical and aggregate objects.

FIG. 6 shows an example object model for cash, with example physical, logical, and aggregate objects for determining cash position.

FIGS. 7A-7B show examples of logical objects related to payables balances aggregate object, as an expanded view.

FIG. 8 shows an example objects with a payables balance aggregate object, as an expanded view.

FIG. 9 shows example use cases for extraction into a data warehouse, integration with cloud applications, and/or to support data transformation or extraction for visualization, reporting, or analysis.

FIG. 10 shows an example approach of attribute defaulting using user-defined rules.

FIG. 11 shows an example table of invoice attribute categories that can be determined based on specific determinants (source attributes) from historical data specific to the customer.

FIG. 12 shows an example overall flow for running machine learning on data and getting the potential defaulting rules to a user for review.

FIG. 13 depicts a simplified diagram of a distributed system for implementing certain aspects.

FIG. 14 is a simplified block diagram of one or more components of a system environment by which services provided by one or more components of an embodiment system may be offered as cloud services, in accordance with certain aspects.

FIG. 15 illustrates an example computer system that may be used to implement certain aspects.

FIG. 16 shows example fields of a payables domain cluster and some of the logical objects and the fields to be vectorized.

### DETAILED DESCRIPTION

A description details providing access, via a read-optimized database service, to logical sets of resources without providing access to other logical sets of resources and without providing direct access to the underlying database structures. The description is provided in the following sections:
READ-OPTIMIZED DATABASE SERVICE
LOGICAL SETS OF RESOURCES CORRESPONDING TO FUNCTIONAL AREAS
ENABLING AND CONSTRAINING CONSUMERS OF FUNCTIONAL AREAS
EXAMPLE OF DATA ARCHITECTURE FOR READ-OPTIMIZED INFORMATION ACCESS AND VECTORIZATION FOR LLMS.
STORING BUILT-IN PROMPT METADATA FOR LOGICAL OBJECTS IN RODS.
USE OF LARGE LANGUAGE MODEL AND MACHINE LEARNING FEATURES.
CONFIGURING AND DEPLOYING USER-DEFINED DEFAULTING RULES FOR OPERATIONS
ACCESS TO AGGREGATE OBJECTS VIA REST
COMPUTER SYSTEM ARCHITECTURE

The steps described in individual sections may be started or completed in any order that supplies the information used as the steps are carried out. The functionality in separate sections may be started or completed in any order that supplies the information used as the functionality is carried out. Any step or item of functionality may be performed by a personal computer system, a cloud computer system, a local computer system, a remote computer system, a single computer system, a distributed computer system, or any other computer system that provides the processing, storage and connectivity resources used to carry out the step or item of functionality.

Workloads on database can be broadly classified as transactional or intensive read-only or otherwise read-dominant. Transactional workloads support day to day business transaction data entry/retrieval on small sets of data and intensive read-only or read-dominant workloads support operational reporting, analytics as well as data extraction on larger data sets. Separation of these workloads shields influence of running one workload from another as well as scaling underlying resources for these workloads independently. Further, data structures specific to read intensive use cases can be built to simplify supporting various read intensive use cases as well as leverage them for AI use cases.

Applications such as Oracle® Fusion Applications can support both transactional and inquiry flows with a single Oracle database instance. In this scenario, the same database instance serves both the day to day transactional data entry/retrieval as well as the intensive read-only or otherwise read-dominant use cases such as operational reporting and analytics (for example, by using Oracle Transactional Business Intelligence (OTBI)), data extractions (information access) (for example, by using Business Intelligence Publisher (BIP) to other systems such as Oracle Fusion Analytics Warehouse (FAW)), intensive read-only use cases, read access use cases where write operations are used in limited scenarios (e.g., system configuration, limited updates, etc.), or any other use cases where workload typically includes more read operations than other (e.g., write) operations (“read-dominant” workload in that read operations outnumber or are expected to outnumber write or other operations). Simultaneous usage can potentially cause periodic performance degradations/potential disruptions to critical day to day transactional activities. To avoid this delay, read intensive operations may be throttled or restricted, limiting the business use cases that can be supported for read intensive use cases.

In one embodiment, a RODS, Read Optimized Data Store, helps overcome the above infrastructural limitations, while also standardizing the data architecture to optimize for read use cases. The Read-Optimized Data Store is “read optimized” by using columnar storage (column-oriented storage) to promote read-efficient data retrieval by column rather than transaction-efficient data storage that uses row-oriented storage. As records are written transactionally in row-oriented storage format (e.g., where rows or records having many columns (3, 10, 20, or more) are stored contiguously or otherwise together with adjacent rows or records having many columns), RODS may prepare the data for consumption by converting the row-oriented data into a column-oriented version (e.g., where column values from many (3, 50, 1000, or more) records or rows are stored contiguously or otherwise together with adjacent columns belonging to many rows) or copy of the data that is accessible for performing efficient read operations. The column-oriented version allows efficient retrieval of column(s) of data that satisfy certain constraints, such as employees with salaries within a range, goods that cost over a threshold amount, or messages sent before a certain date. Such conditions may be efficiently evaluated against contiguous columnar data without parsing through columns that are irrelevant to the data retrieval task.

Data stored in heterogenous database environments involving many different data structures can be simplified such that pathways or areas of functionally driven information are referenced using the same logical resource identifier. The logical resource identifier may be mapped to same or different underlying database structures, simplifying the underlying complexity for read use cases. Simplifying the underlying complexity is particularly helpful to the read use cases that involve explaining the available data structures to a large language model for determining what data to read and return, as large language models may be misled by unnecessary complexity that is not tied to a pathway or area of functionality. RODS provides a near-real time read optimized application-accessible data source, specifically for operational reporting and information access use cases. RODS enables clear separation of transaction processing and data consumption workloads, which benefits both use cases as well as provides the ability to scale these workloads independently. RODS may use a read optimized columnar database, for example, Autonomous Data Warehouse (ADW) or any other column-oriented data store or format, to store and retrieve data. RODS may also leverage Golden Gate (GG) or any other data synchronization service to replicate or otherwise synchronize data from an underlying database (DB) in near real time. Unlike a transactional database, in some embodiments, RODS does not accept commands to change the data in the underlying database structures, and RODS does not tie up the underlying database structures with locks or other queues associated with transaction processing.

In some embodiments, access to RODS is allowed via a standardized object model which abstracts the physical constructs like joins, filters etc. from data consumers. For example, invoice objects may be split into invoice headers, line items, and other tables, along with reference information like supplier names, transaction dates, etc., are in other tables. By flattening invoice objects to include the data joined from the different tables, a consumer may interact with an invoice object as an object without requiring an explanation, understanding, or navigation of complex multidimensional hierarchy used by the database to efficiently store and manage invoice objects. The object model allows RODS to provide standardized, easy to consume and consistent semantic definitions of application platform objects to various consumers of the application platform.

Separation of workloads also allows expansion of use cases that can be supported, in addition to analytics. Specifically, a data warehouse may provide native or integrated support for multiple AI features such as Vector Search, In-Database Machine Learning (ML). Leveraging AI features allows RODS to streamline and automate key business processes for the customer, often times tailor made for the customer. RODS enables leveraging the vast amount of existing enterprise data, specific to each customer, by vectorizing data and running ML models within the database, without requiring to move the enterprise data out to a different vector store.

RODS is proposed to be used as a common data store for both enterprise analytics and running AI workloads including vectorization and running ML models. Due to the standardized data model, learning may account for known relationships between objects in the standardized model, and results determined from the learning may be exposed in the standardized model as first-class objects that are accessible via an application programming interface (API) or other interface to RODS.

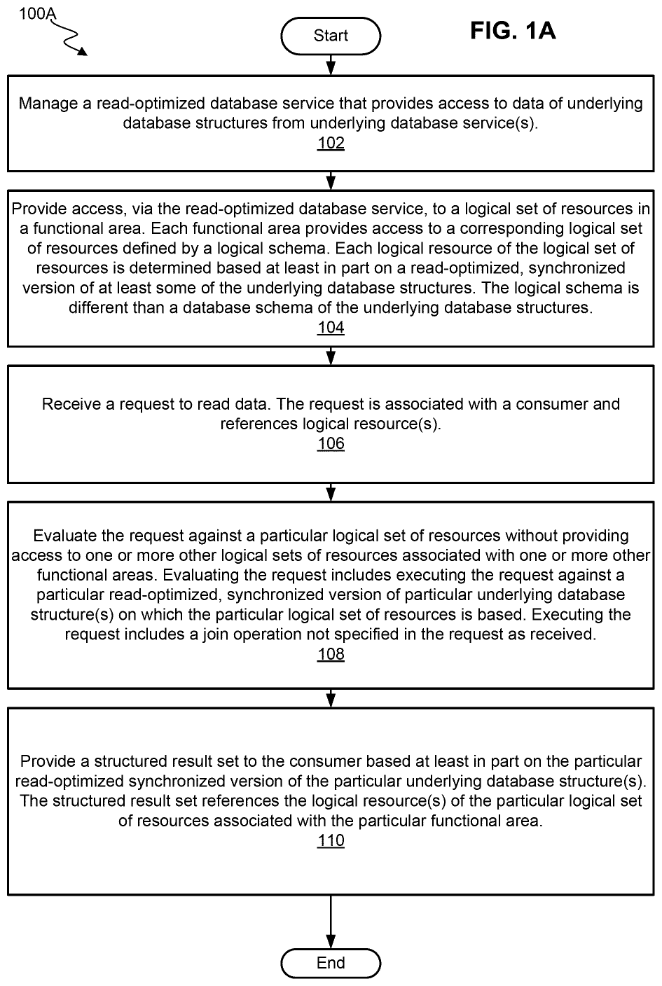

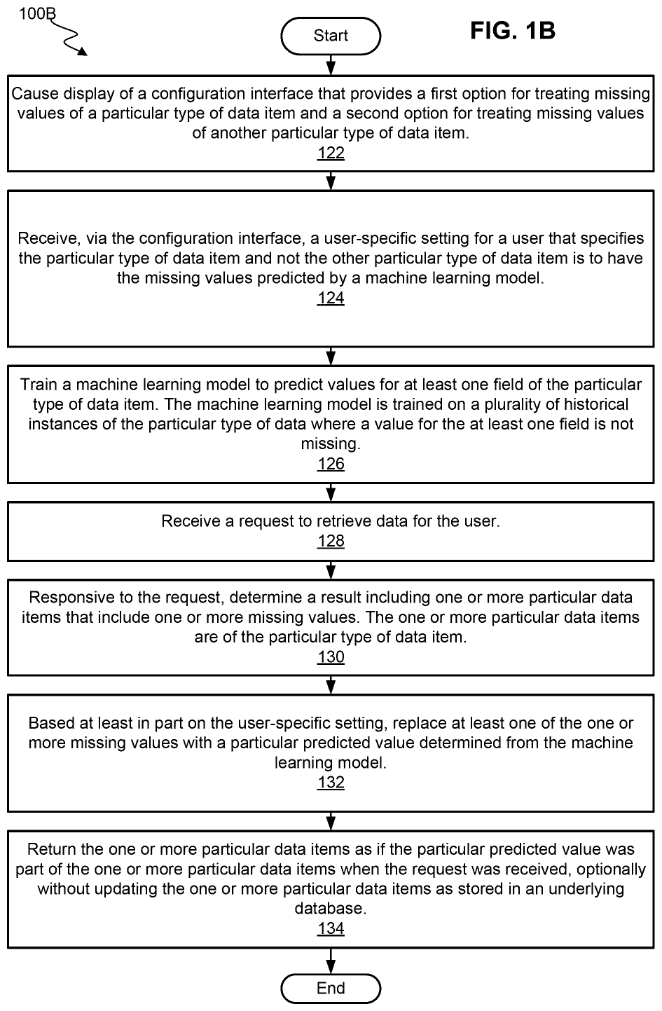

FIG. 1A illustrates a flow chart of an example process that uses a read-optimized data management service to access objects without exposing underlying database structures or other pathways. As shown in block 102, a data management system manages a read-optimized database service that provides access to data of underlying database structures from underlying database service(s). In block 104, the data management system provides access, via the read-optimized database service, to a logical set of resources in a functional area. Each functional area provides access to a corresponding logical set of resources defined by a logical schema. Each logical resource of the logical set of resources is determined based at least in part on a read-optimized, synchronized version of underlying database structure(s) of the underlying database structures. The logical schema is different than a database schema of the underlying database structures. In block 106, the data management system receives a request to read data. The request is associated with a consumer and references logical resource(s). In block 108, the data management system evaluates the request against a particular logical set of resources without providing access to one or more other logical sets of resources associated with one or more other functional areas. Evaluating the request includes executing the request against a particular read-optimized, synchronized version of particular underlying database structure(s) on which the particular logical set of resources is based. Executing the request includes a join operation not specified in the request as received. In block 110, the data management system provides a structured result set to the consumer based at least in part on the particular read-optimized, synchronized version of the particular underlying database structure(s). The structured result set references the logical resource(s) of the particular logical set of resources associated with the particular functional area.

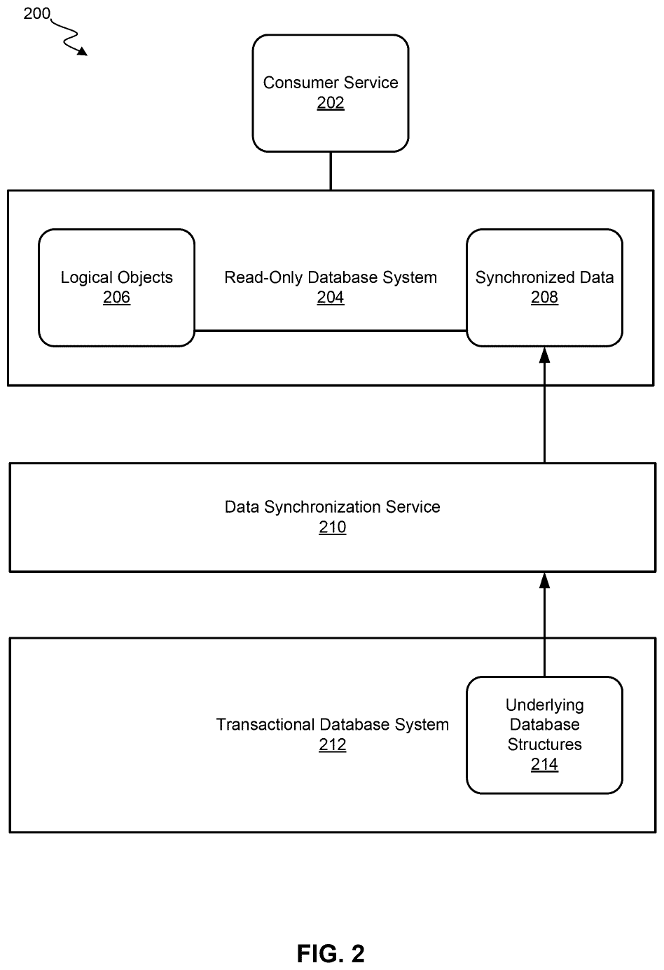

FIG. 2 illustrates a system diagram showing an example system that uses a read-optimized data management service to access logical objects without exposing underlying database structures. As shown, consumer service 202 consumes logical objects 206 from read-optimized database system 204, which determines logical objects 206 based on synchronized data 208, which may be optimized for read access, for example, using a column-oriented storage format. Synchronized data 208 is updated by data synchronization service 210, which is integrated with transactional database system 212 to synchronize data as underlying database structures 214 are updated.

### Read-Optimized Database Service

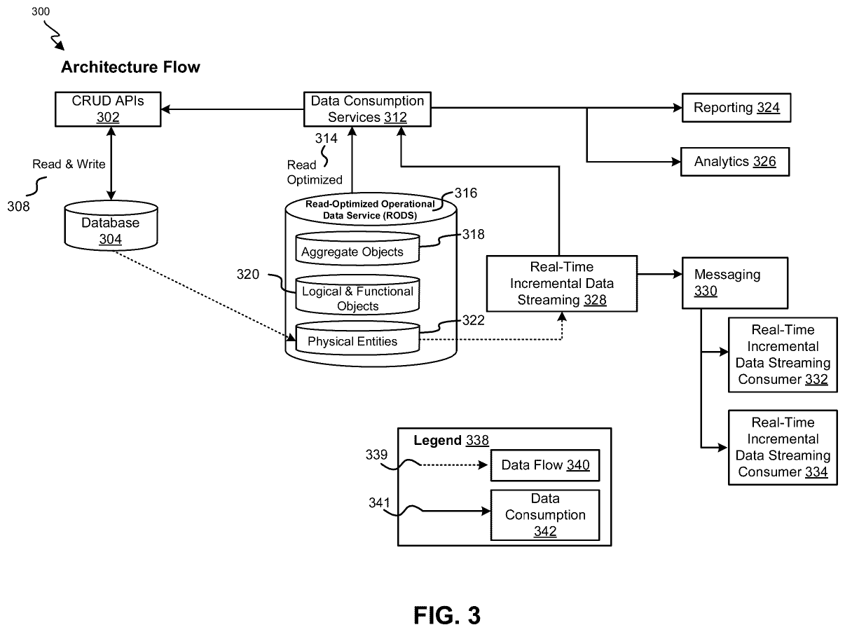

In one embodiment, a database stores underlying database structures that may be managed via an interface provided by a database management system. FIG. 3 shows an example overall architecture 300. As shown by data flow 340, a data synchronization service such as a replication service (for example, Golden Gate), may synchronize data from the database 304 as the database 304 is updated by the database management system. The synchronized data gets pushed into a read-optimized operational data service (RODS) 316 via physical entities 322, which has logical and functional objects 320 built on top of data expected to be written. For example, the logical and functional objects 320 may be built based on joins and relationships between synchronized data from the underlying database structures from the database 304. Aggregate objects 318 may be further built on top of the logical and functional objects 320 to provide first-class objects that may be directly referenced via read-optimized operations 314 via an interface to RODS.

In one embodiment, RODS 316 includes dynamically updated vector embeddings of values, aggregated values, and other values derived from raw data and/or used by machine learning models. The values are stored and accessible through RODS 316, created and maintained as data is synchronized. The derived values may be determined on request in RODS 316, for example, from data consumption services 312, and the values and derived values are accessible via an interface to RODS 312 without requiring any acknowledgement of the underlying complexity of database 304 or physical entities 322 in the request to RODS. Data consumption services 312 may use consumed data for reporting 324, analytics 326, or for any other purpose.

The underlying transactional database system including database 304 may store transactional, setup and reference data in normalized physical tables. In one embodiment, the underlying transactional database system supports read/write operations 308 on data via (Create, Read, Update, and/or Delete Application Programming Interfaces) CRUD APIs 302 or other services.

Data from database 304 of the underlying transactional database system is synchronized to RODS 316 in near-real time without requiring transformation, for example, using Golden Gate/Varidata or any other data synchronization service. The physical schema on RODS 316 may be same as it is in database 304 of the underlying transactional database system. In various embodiments, the data synchronization service may guarantee transactional consistency for synchronized data. When data is committed to the database 304 of the underlying transactional database in a transaction, the data synchronization service makes the changes available and only then allows the commit to be reflected in RODS 316. In another embodiment, transactions may be split and synchronized in multiple pieces, while preserving transactional integrity on RODS.

RODS 316 supports read-optimized access 314 (e.g., no write access or access optimized for read access using columnar data representations, whether or not write access is allowed) via a logical data model, which may be accessed using a standardized data consumption service such as, in one example, BOSS for reporting/data extraction use cases. The logical data model is based on metadata and provides a denormalized/aggregated view of the data stored in the underlying database structures synchronized from database 304 the underlying transactional database system. In one embodiment, RODS 316 is metadata-based, and there is no additional storage of denormalized data/aggregated data within RODS 316. In other words, RODS 316 does not need to manage clean/dirty bits or caches for data sets, as the aggregated data 318 is built on top of the underlying physical data 322 and not separately persisted in value form other than to assemble a response to a particular query. Instead, RODS 316 includes the logical objects 320 and aggregate objects 318 as a translation layer to the underlying physical entities 322. The translation layer 318-320 is a virtual layer built on top of the physical layer 322 such that evaluation of the virtual layer to respond to queries changes as the underlying physical layer 322 changes based on the synchronized data changes. RODS also enables batch/real time consumption of both physical data 322 and/or logical data 320.

As data is changed in the synchronized physical layer 322, a change data capture service, such as Golden Gate, may provide real-time incremental data streaming 328 to a messaging service 330 for use by a data warehouse or other real-time incremental data streaming consumer 332 or 334.

### Logical Sets of Resources Corresponding to Functional Areas

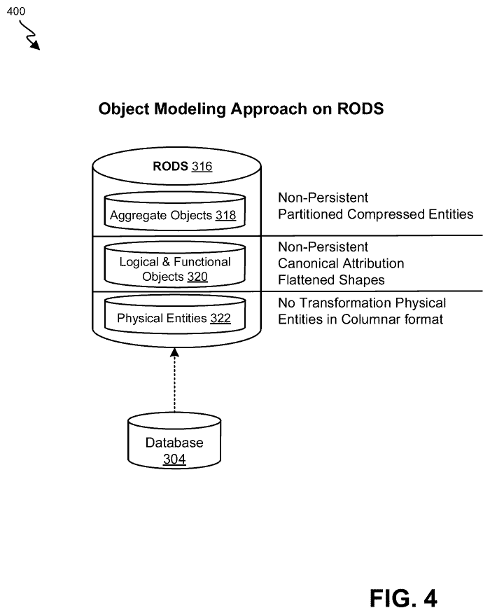

In various embodiments, RODS allows storage of synchronized data from the underlying database structures of an underlying transactional database system with or without transformation. In this sense, the data is normalized to the original form. FIG. 4 shows an example object modeling approach 400 on RODS 316. As shown, a physical schema 322 on RODS 316 is same as database 304 of the underlying transactional database system, and a data synchronization service is used for synchronization of data with or without transformations. In one example, Veridata promotes consistency of data across the transactional database system and RODS 316. In the same or a different example, Autonomous Data Warehouse or another data warehouse or columnar storage system may store data using default hybrid columnar (HCC) compression for optimizing read scenarios. Hybrid Columnar Compression compresses data at the column level rather than at the row level, with settings to optimize compression ratio or query performance or a mix of both.

In one embodiment, logical objects are represented using metadata, which is non-persistent and maps to the underlying database structures. The metadata provides a denormalized view of objects (closer to real world view) which includes both the transactional data and the relevant reference data. The metadata captures the tables/attributes involved, join/filter conditions needed, etc. For example, the metadata may capture join conditions, filter conditions, or a combination thereof. Further, the actual query to RODS is optimally constructed based on attributes chosen when querying the logical object rather than being directed to the underlying database structures.

Aggregate objects may also be expressed using metadata, which is non-persistent and is built on top of the logical objects that provides a simple interface to aggregate data. Analytic view allows defining dimensions, hierarchies and facts metadata constructs. These constructs are defined on top of already defined logical objects. This enables consumers to use simple SQL to perform complex multi-dimensional aggregations without dealing with the underlying complexity of the normalized data model including required joins, filters, aggregation logic, etc. Using simple flattened data structures reduces overall operational costs by reducing a need for multidimensional data analytic tools like Essbase, which visualizes slices and aggregations of multidimensional data. Aggregate objects may be implemented as Oracle Analytic views (which may be metadata based and not separately persisted) or any other aggregation of logical and functional objects 320. Analytic views provide ability to generate aggregates based on user-selected dimensions and hierarchies using simple SQL without writing complex queries. Further, an Analytic View engine may generate an optimal SQL query that is used for the computations on the fly.

Both logical and aggregate objects may be made available by default for all customers, enabling them to leverage these objects using an interface to RODS as per the business use case, without requiring each customer to build their own custom code on top of the physical model. Further, any further physical schema level updates are opaque to the end users and will be taken care by updating the logical and aggregate models that are shipped to the customers.

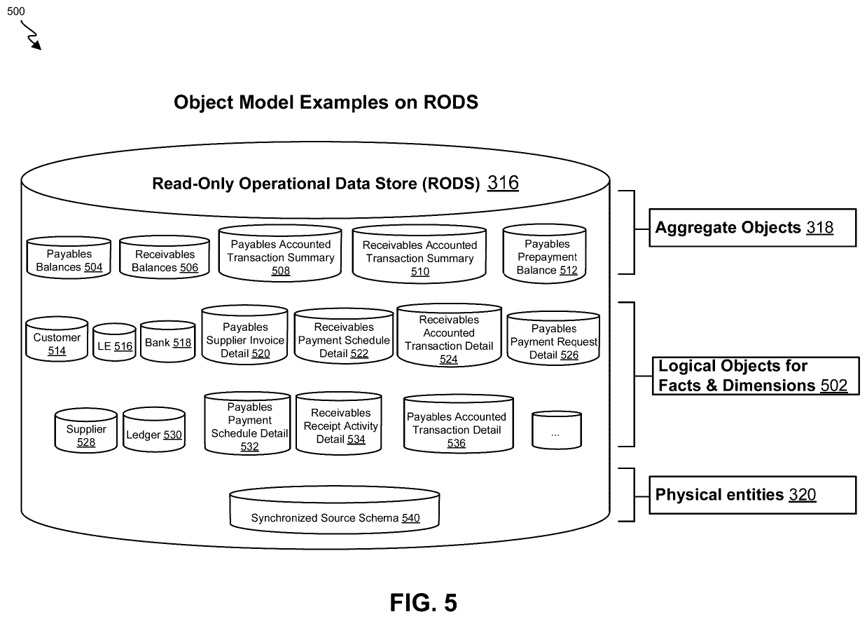

FIG. 5 shows object model examples 500 on RODS 316. FIG. 5 shows examples of physical 320, logical 502, and aggregate 318 objects. As shown, aggregate objects 318 or functional areas may be selected as Payables Balances 504, Receivables Balances 506, Payables Accounted Transaction Summary 508, Receivables Accounted Transaction Summary 510, and/or Payables Prepayment Balance 512. These aggregate objects 318 may be operated on along with logical objects 502 for facts and dimensions related to the aggregate objects 318. For example, Customer 514, Legal Entity 516, Bank 518, Payables Supplier Invoice Detail 520, Receivables Payment Schedule Detail 522, Receivables Accounted Transaction Detail 524, Payables Payment Request Detail 526, Supplier 528, Ledger 530, Payables Payment Schedule Detail 532, and Receivables Receipt Activity Detail 534, Payables Accounted Transaction Detail 536, are some of the logical objects 502 and accessible in relation to the aggregate objects 318. The aggregate objects 318 and logical objects 502 are constructed on top of the physical entities 320 as synchronized source schema 540 that is synchronized from the underlying database structures so as to not require separate or redundant storage of objects or aggregations in RODS.

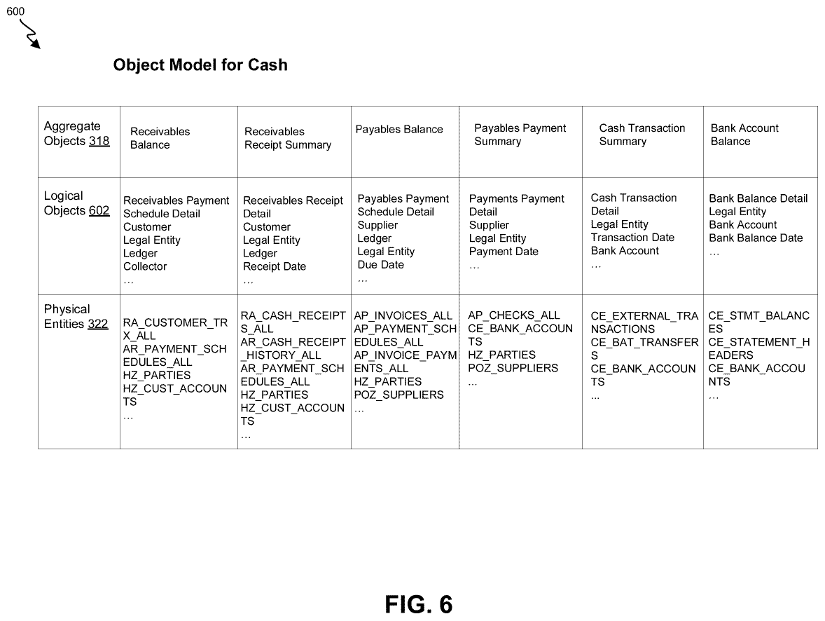

FIG. 6 shows an example object model 600 for cash, including example Physical 322, Logical 602, Aggregate 318 objects for determining cash position. As shown, a functional area of logical objects or “aggregate object” of Receivables Balance may be used to query Receivables Payment Schedule, Detail, Customer, Legal Entity, Ledger, Collector, and/or other logical objects accessible via the Receivables Balance aggregate object. These logical objects may be defined as metadata mappings on the underlying physical entities synchronized from the underlying transactional database system, including underlying database structures or database tables such as RA_CUSTOMER_TRX_ALL, AR_PAYMENTS_SCHEDULES_ALL, HZ_PARTIES, HZ_CUST_ACCOUNTS, etc. Various other aggregate objects or areas of logical objects are shown in FIG. 6, each with corresponding logical objects, and each of those with corresponding physical entities.

The join operations that would be used to merge data together from the different tables to answer a query in a transactional database do not need to be supplied for RODS, as the join operations are stored as mappings in the metadata that pull in the right row from the right table in the right context to answer a query relating to the functional area of logical objects. In this manner, a query for a single logical object in RODS may automatically cause an underlying query against multiple underlying database structures that are involved in resolving values for the logical object. In this manner, join operations and additional tables needed for resolution are attached to the query to encompass a larger and more complicated footprint against the underlying database structures, but only to the extent to resolve the logical objects defined for the functional area without supplying information about logical objects in other functional areas that are not part of the functional area being used for the query.

As another example in FIG. 6, the Payables Balance or invoice data area includes logical objects such Payables Payment Schedule, Detail, Supplier, Ledger, Legal Entity, Due Date, etc., and those logical areas use underlying physical entities or database structures storing transactional data such as AP_INVOICES_ALL, AP_PAYMENT_SCHEDULES_ALL, AP_INVOICE_PAYMENTS_ALL, HZ_PARTIES, AND POZ_SUPPLIERS, etc. In the example, AP_INVOICES_ALL is a header table. AP_PAYMENT_SCHEDULES_ALL captures the invoice schedule in which the invoice was paid, as invoices may be paid in multiple schedules. AP_INVOICE_PAYMENTS_ALL captures how many times payments happen for the invoice. Denormalized structures such as HZ_PARTIES and POZ_SUPPLIERS may store information (name, address, contact information, etc.) about the parties and suppliers, respectively, for which identifiers may be referenced in the other tables, such as invoices referencing which parties and/or suppliers are involved in the invoice. GL_LEDGERS may include a ledger name that is also referenced by other objects.

In another example, Payables Payment Schedule Detail lists the installments for all the invoices in the system. This includes details about the amount, due date, payment method, remittance details, payment priority, Invoice Number, Supplier Name, Ledger Name etc. This data may be defined on top of physical tables such as AP_PAYMENT_SCHEDULES_ALL, AP_INVOICES_ALL, POZ_SUPPLIERS, GL_LEDGERS, etc.

In the Payables Payment Schedule Detail example, a Grain object such as AP_PAYMENT_SCHEDULES_ALL contains details of the scheduled payments for a supplier invoice with details such as installment amount, discount available, payment priority, payment status, and so on. Each supplier invoice has one or more installments.

In the example, a reference object such as AP_INVOICES_ALL contains information about supplier invoices such as invoice number, invoice date, invoice amount, supplier (id), Ledger (id), currency and so on. Each invoice has only one supplier.

Other reference objects include POZ_SUPPLIERS, which contains information about suppliers such as supplier (id), supplier name, supplier type, etc., and GL_LEDGERS, which contains information about the ledgers/ledger sets with attributes such as ledger (id), ledger name, ledger currency, etc.

Another example logical object is Payables Supplier Invoice Detail, which details the specific product or service for which the supplier is billing the buyer. This logical object is defined on top of physical tables such as AP_INVOICE_LINES_ALL, POZ_SUPPLIERS, etc.

Another example logical object is Supplier, which provides detail of the Supplier that is an entity or individual from whom an organization procures goods or services. Suppliers play a role in the procurement and payment processes, and managing supplier information is a part of financial operations. The supplier logical object may be built on top of physical tables such as POZ_SUPPLIERS, POZ_SUPPLIER_SITES_ALL_M, etc.

An example Aggregate Object includes Payables Balance, which provides aggregation of Payment Schedules with outstanding balances in invoice currency for all payable invoice transactions. Payables Balances is built on top of existing logical objects, such as Payables Payment Schedule Detail (Fact), Supplier (for Dimension and Hierarchy), Ledger (for Dimension, Hierarchy), etc.

In various embodiments, the aggregate objects are exposed via a RODS API to allow consumers of the API to retrieve data pertaining to the corresponding aggregate object. For example, a Receivables Receipt Summary query may involve requests for data relating to a fixed set of logical objects including, for example, Receivables Receipt Detail, Customer, Legal Entity, Ledger, and Receipt Date, and those logical objects are determined based on underlying database structures including RA_CASH_RECEIPTS_ALL, AR_CASH_RECEIPTS_HISTORY_ALL, AR_PAYMENT_SCHEDULES_ALL, HZ_PARTIES, and HZ_CUST_ACCOUNTS. Another consumer of the API may submit a Payables Payment Summary query that involves requests for data relating to Payments, Payment Detail, Supplier, Legal Entity, Payment Date, etc., and those logical objects may be determined based on underlying database structures including AP_CHECKS_ALL, CE_BANK_ACCOUNTS, HZ_PARTIES, and POZ_SUPPLIERS. Although both queries may end up accessing HZ_PARTIES, they do so only under the constraints of resolving the corresponding logical objects. The Receivables Receipt Summary query might not have access to read the AP_CHECKS_ALL or CE_BANK_ACCOUNTS objects since the logical objects for that query do not use those tables to resolve values. Similarly, the Payables Payment Summary query may not have access to read the RA_CASH_RECEIPTS_ALL and AR_CASH_RECEIPTS_HISTORY_ALL objects since the logical objects for that query do not use those tables to resolve values. In this manner, in one embodiment, access may be constrained to or predominated by read-only operations and may be further constrained to only that data or sub-sets of data which the read-only access pertains as specified for the read-only query (e.g., one or more of the aggregate objects and not one or more others of the aggregate objects).

Further examples of physical, logical, and aggregate objects are provided below.

In various examples, payables invoice data is stored across multiple tables and transaction data, such as in AP_INVOICES_ALL, AP_INVOICE_LINES_ALL, AP_PAYMENT_SCHEDULES_ALL, etc., and reference data is stored in tables such as POZ_SUPPLIERS (supplier name), GL_LEDGERS (ledger name), etc.

In the examples, Payables Payment Schedule Detail lists the installments for all the invoices in the system. This list of installments includes details about the amount, due date, payment method, remittance details, payment priority, Invoice Number, Supplier Name, Ledger Name, etc. The details may be defined on top of physical tables such as AP_PAYMENT_SCHEDULES_ALL, AP_INVOICES_ALL, POZ_SUPPLIERS, GL_LEDGERS, etc.

In the examples, a grain object may include AP_PAYMENT_SCHEDULES_ALL, which contains details of the scheduled payments for a supplier invoice with details such as installment amount, discount available, payment priority, payment status, and so on. Each supplier invoice has one or more installments in the example.

In the examples, reference objects may include:

AP_INVOICES_ALL, which contains information about supplier invoices such as invoice number, invoice date, invoice amount, supplier (id), Ledger (id), currency and so on. Each invoice has only one supplier in the example.

POZ_SUPPLIERS, which contains information about suppliers such as supplier (id), supplier name, supplier type, etc.

GL_LEDGERS, which contains information about the ledgers/ledger sets with attributes such as ledger (id), ledger name, ledger currency, etc.

In the examples, Payables Supplier Invoice Detail includes details of the specific product or service for which the supplier is billing the buyer. These details may be defined on top of physical tables such as AP_INVOICE_LINES_ALL, POZ_SUPPLIERS, etc.

In the examples, Supplier provides detail of the Supplier that is an entity or individual from whom an organization procures goods or services. Suppliers play a role in the procurement and payment processes, and managing supplier information promotes efficient financial operations. The supplier detail may be built on top of POZ_SUPPLIERS, POZ_SUPPLIER_SITES_ALL_M, etc.

In the examples, Aggregate Objects may include: Payables Balances, which provides aggregation of Payment Schedules with outstanding balances in invoice currency for all payable invoice transactions. Payables balances may be built on top of existing logical objects, such as Payables Payment Schedule Detail (Fact), Supplier (for Dimension and Hierarchy), Ledger (for Dimension, Hierarchy), etc.

In various embodiments, different cloud services may access the API to invoke requests relating to different functional areas, and the different cloud services may be constrained to only the functional areas for which they are connected to invoke requests. In other words, some service(s) may invoke the API to use a first set of functional areas corresponding to a first set of logical objects, and other service(s) may invoke the API to use a second set of functional areas corresponding to a second set of logical objects, and each service may be constrained either by an agent managing the service or by RODS to prevent the service from accessing functional areas or logical objects outside of the scope for which the API was invoked.

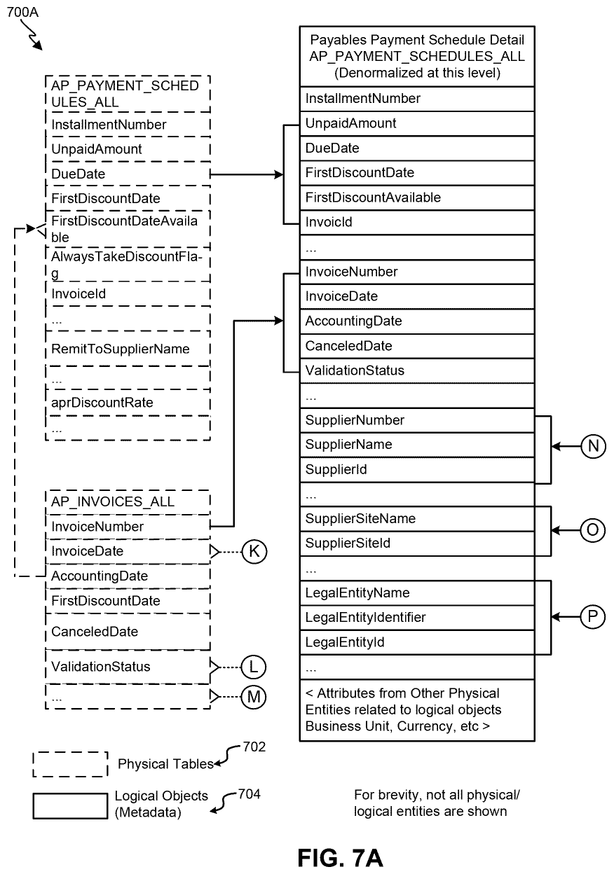

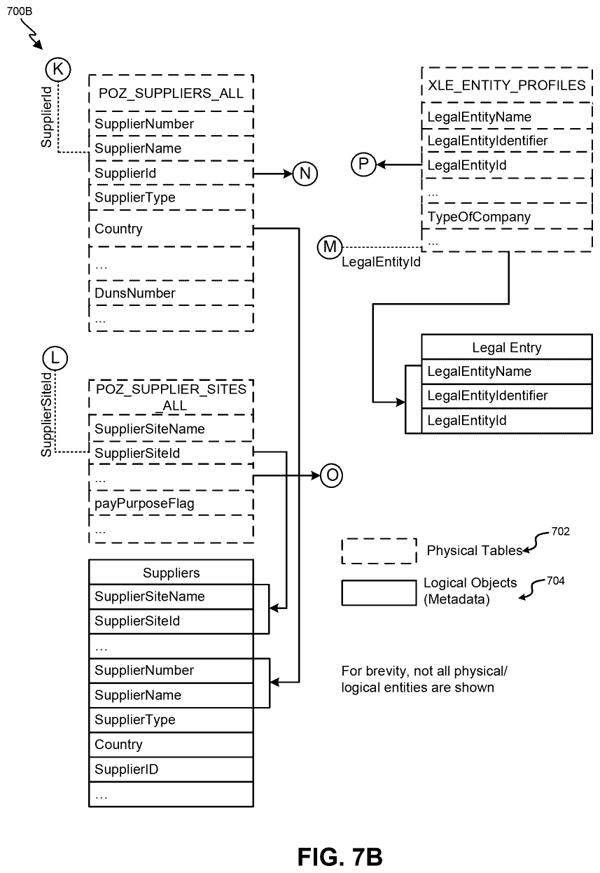

FIGS. 7A-7B show examples 700A-700B of logical objects related to a payables balances aggregate object, as an expanded view, with physical tables 702 indicated by dashed lines and logical objects indicated by solid lines. Connections K, L, and M are shown from FIG. 7A to FIG. 7B, and connections N, O, and P are shown from FIG. 7B to FIG. 7A.

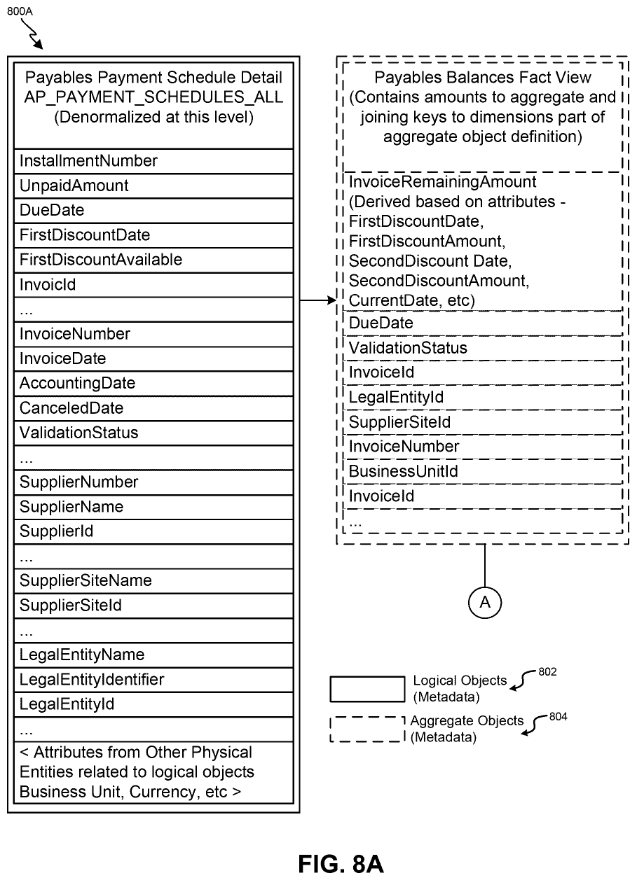

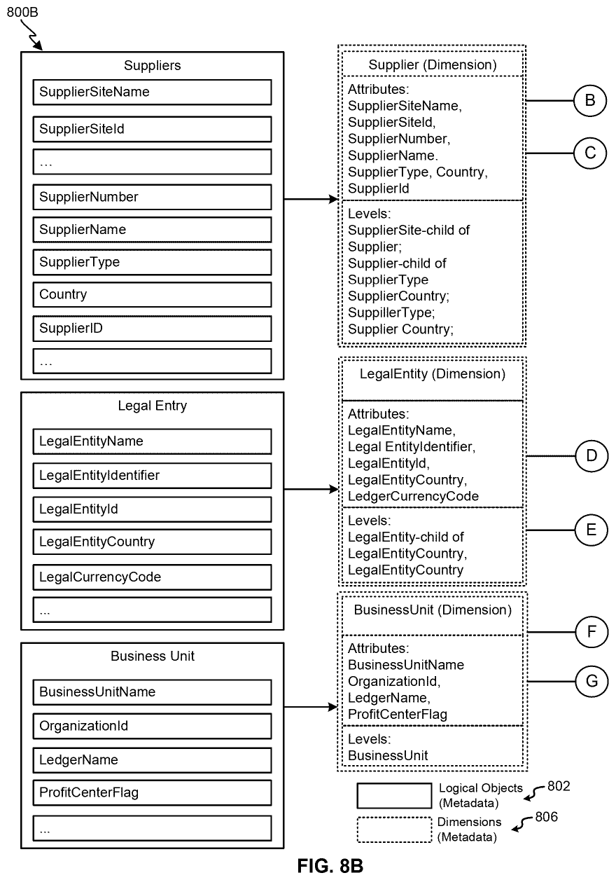

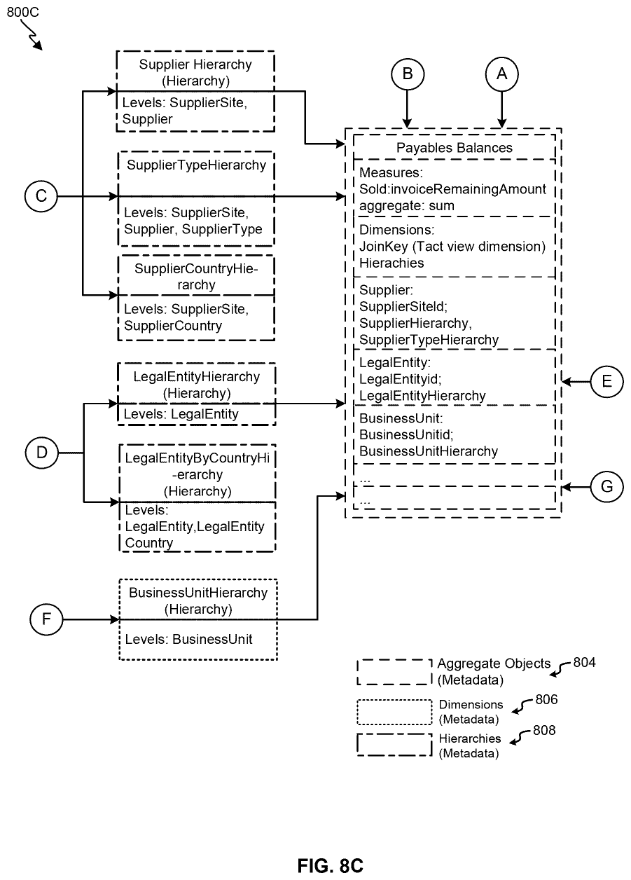

FIGS. 8A-8C show example objects with a payables balance aggregate object, as an expanded view. As shown in FIG. 8A, logical objects 802 are indicated with a solid line, and aggregate objects 804 are indicated with a dashed line, with connection A to FIG. 8C. In FIG. 8B, logical objects 802 are indicated with a solid line, and dimensions 806 are indicated with a dotted line, with connections B, C, D, E, F, and G to FIG. 8C. In FIG. 8C, aggregate objects 804 on the right are indicated with a uniform dashed line, dimensions 806 on the left are indicated with a dotted line, and hierarchies 808 on the upper left are indicated with a non-uniform dashed line, with connection A from FIG. 8A and connections B, C, D, E, F, and G from FIG. 8B.

### Enabling and Constraining Consumers of Functional Areas

If a query is being automatically constructed by a large language model, the large language model might not be aware of the logical object structure of functional areas other than the functional areas for which the large language model is providing a recommendation. Similarly, the application consumer or RODS may constrain a query generated by the large language model or other user or service to access only the functional area for which the query could have reasonably pertained without allowing queries on other functional areas unrelated to a user request or unrelated to a user interface or supplied context for which the user request is received.

Additionally or alternatively, the application consumer or RODS may constrain a query generated by a large language model or other user or service to access only the logical objects of the functional area and not directly query the underlying database structures that provide data to resolve those logical objects. By constraining the query as such, underlying database structures such as “HZ_PARTIES,” which may be used in different ways to support a variety of functional areas, is only accessible to the extent needed to resolve the logical objects and details about the logical objects and is not directly query-able to attain additional details. Such additional data protection may cause, regardless of the consumer of RODS, the consumer to be limited to answering questions of the type corresponding to the functional area identified in the request.

RODS enables simplified, customized and adaptive data consumption based on consumption requirements.

The data consumption is simplified through the standardized logical layer, thus eliminating the need for each consumer to understand intricacies of the physical data model and write/maintain complex SQLs. Instead the logical objects, which are generally consumed, are prebuilt.

The data consumption is customized, as data shapes can be customized to add filters as well as choose attributes from the pre-built logical/aggregate shapes.

The data consumption is adaptive, as data can be consumed in real time (reporting/streaming) or in batches (for data extraction) on top of the same logical model.

Without using RODS, database-centric data consumption pathways may be configured to understand the underlying database structures and the joins necessary to get certain types of functional information out of the database. As a result, these database-centric pathways carry a significant amount of inefficiency, inconsistency, and unreliability. This also results in a significant load on the transactional database that may interfere with ongoing transaction committals to the database.

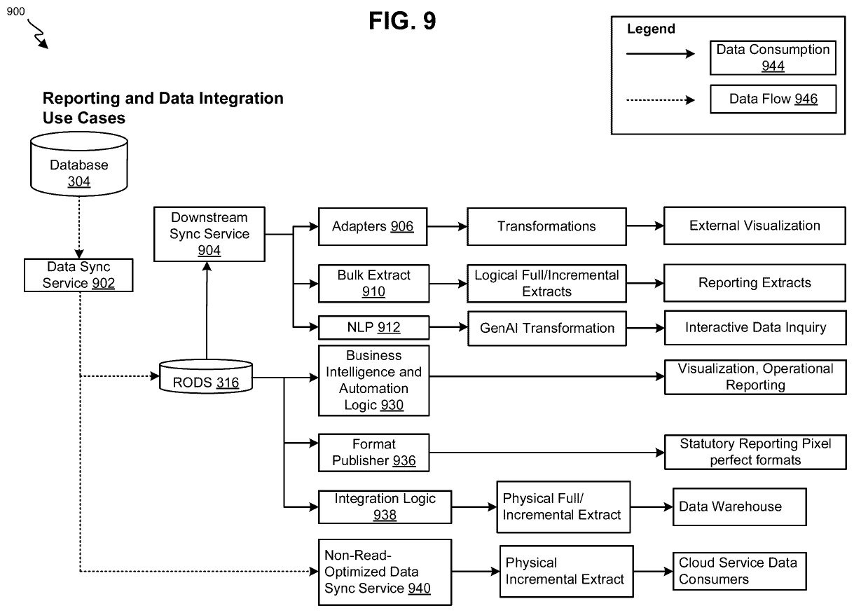

FIG. 9 shows example use cases for extraction into a data warehouse, integration with cloud applications, and/or to support data transformation or extraction for visualization, reporting, or analysis in a system that uses RODS. In FIG. 9, Data consumption flows 944 are shown in solid lines, and data flows 946 are shown in dotted lines. Other use cases include Natural Language Processing (NLP) based data querying 912 using downstream synchronization services 904 on RODS 316, logical object based full/incremental extracts from Bulk extract 910 using downstream sync services 904 on RODS 316, and transformations from adapters 906. Business Intelligence and Automation Logic 930 and/or Format Publisher 936 may be used for reporting use cases that run on RODS 316, instead of on the database 304, and potentially achieving better performance. As shown, the Downstream Sync Service 904 may interact with RODS accessing the logical objects based on the functional areas without requiring underlying knowledge of the underlying database structures and the joins necessary to get certain types of functional information out of the database. This is particularly useful when using generative artificial intelligence to contribute to a determination of what data to query, based on simpler logical objects rather than the joins of underlying database structures. As a result, this process improves the overall efficiency, consistency, and reliability of the functionality provided through Downstream Sync Service 904. RODS promotes integrations on meaningful high-level data rather than low-level, cumbersome database structures and the join operations between them. As a result, this process improves the overall efficiency, consistency, and reliability of the functionality provided through simplified integrations.

### Example of Data Architecture for Read-Optimized Information Access and Vectorization for LLMS

Applications and application platforms have traditionally supported both transactional and inquiry flows with a single database instance. The same database instance may serve both the day to day transactional data entry/retrieval as well as the intensive read-only or otherwise read-dominant use cases such as operational reporting and analytics, and/or data extractions (information access) to other systems. Simultaneous usage can potentially cause periodic performance degradations/potential disruptions to critical day to day transactional activities, thus promoting a limitation of read intensive operations, thus limiting the business use cases that can be supported for read intensive use cases.

RODS, a Read Optimized Data Store, will help overcome the above infrastructural limitations, while also standardizing the data architecture to optimize for read use cases. RODS provides a near-real time read optimized application native data source, specifically for operational reporting and information access use cases. RODS enables clear separation of transaction processing and data consumption workloads, which may benefit both use cases as well as provides the ability to scale these workloads independently. RODS leverages a read optimized column database, for example, using a data warehouse or other column-oriented storage service, to store and retrieve data and leverages a synchronization service to synchronize data from the database, for example, in near real time.

Access to RODS may be allowed via a standardized object model which may abstract the physical constructs like joins, filters etc. from data consumers. This allows standardized, easily consumable and consistent semantic definitions of application native objects to various consumers of applications and/or application platforms.

Separation of workloads also allows expansion of use cases that can be supported, in addition to analytics. Specifically, a data warehouse may provide native or external support for multiple AI features such as Vector Search, In-Database Machine Learning (ML). Leveraging AI features allows RODS to streamline, automate key business processes for the customer, often times tailor made for the customer. RODS enables leveraging the vast amount of existing enterprise data, specific to each customer, by vectorizing data and running ML models within the database, without requiring moving the enterprise data out to a different vector store.

RODS is proposed to be used as a common data store for both enterprise analytics and running AI workloads including vectorization and running ML models.

### Example Architecture and Object Modeling

FIG. 3 shows an example overall architecture for a read-optimized data service.
In the example, an application platform's underlying database stores transactional, setup and reference data in normalized physical tables.
In the example, data from the database is synchronized as-is to RODS, which may be a columnar data storage optimized for read operations) using a data synchronization service in near-real time. The physical schema on RODS is the same as or similar to the database (normalized data).
In the example, read-optimized access (e.g., no write access or access optimized for read access using columnar data representations, whether or not write access is allowed) to RODS is via a logical data model, which is accessible by a standardized data consumption service (for example, BOSS for reporting/data extraction use cases). A logical model is based on metadata and provides a denormalized/aggregated view of the underlying data. Since the logical model is metadata based, there is no additional storage of denormalized data/aggregated data within RODS.
In the example, RODS also enables batch/real time consumption of both physical data and/or logical data.

FIG. 4 shows an example object modeling approach on RODS.
In the example, a physical schema on RODS is same or similar as that on the database (normalized data). Synchronization may be performed using a replication tool for replication of data or any other data synchronization service for synchronizing data, such as replication or synchronization with or without transformations. In a particular example, Veridata promotes data consistency across the database and RODS. ADW stores data using default HCC compression for optimizing read scenarios.
In the example, logical objects are represented using metadata, which may be non-persistent. The metadata provides a denormalized view of objects (closer to a real world view), which includes both the transactional data and the relevant reference data. The metadata captures the tables/attributes involved, join/filter conditions used, etc. Further, the actual query may be constructed based on attributes chosen when querying the logical object.
In the example, aggregate objects are also expressed using metadata, which may be non-persistent and built on top of the logical objects. The metadata provides a simple interface to aggregate data. An analytic view allows defining dimensions, hierarchies and facts metadata constructs. These constructs are defined on top of already defined logical objects. The analytic view enables consumers to use simple SQL to perform complex multi-dimensional aggregations without dealing with the underlying complexity of the normalized data model including used joins, filters, aggregation logic, etc. Further, this may help reduce overall operational costs by eliminating additional data stores like Essbase, which may be used for similar aggregation scenarios. Aggregate objects may be implemented as Oracle Analytic views or any other aggregations of the logical and functional objects 320, which may also be metadata based. In a nutshell, analytic views provide an ability to generate aggregates based on user chosen dimensions and hierarchies using simple SQL without writing complex queries. Further, an Analytic View engine may generate an optimal or otherwise efficient SQL query that is used for the computations on the fly.
In the example, both logical and aggregate objects may be made available in a standard product as accessible to many customers without additional customization, enabling customers to leverage these objects as per their business use cases, without requiring each customer to build separate custom code on top of the physical model. Further, any further physical schema level updates may be opaque to the end users and may be performed by updating the logical and aggregate models that are in the standard product.

Below is an example REST request on the payables balance aggregate shape to aggregate payables balance by all suppliers for a specific legal entity.

### Example REST Request on Payables Balance Aggregate Object

```
{
  “analyticViews”: {
    “PayablesBalance”: {
      “module”: “oraErpCorePayablesInvoices”,
      “name”: “PayablesBalance”,
      “measureAliases”: {
        “invoiceRemainingAmount”: “invoiceRemainingAmount”
      },
      “dimensions”: {
        “legalEntity”: {
          “legalEntityHierarchy”: {
            “aliases”: {
              “$memberName”: “legalEntityHierarchymemberName”,
              “$depth”: “legalEntityHierarchydepth”,
              “$levelName”: “legalEntityHierarchylevelName”
            }
          }
        },
        “supplier”: {
      “supplierHierarchy”: {
      “aliases”: {
        “$memberName”: “supplierHierarchymemberName”,
        “supplierName”: “supplierHierarchysupplierName”
      }
      }
    }
    }
      }
  },
  “viewQueries”: { },
  “return”: [
    {
      “name”: “legalEntityHierarchydimensionDisplayName”
    },
    {
      “name”: “legalEntityHierarchymemberName”
    },
    {
      “name”: “legalEntityHierarchydepth”
    },
    {
      “name”: “supplierHierarchydimensionDisplayName”
    },
    {
      “name”: “supplierHierarchysupplierName”
    },
    {
      “name”: “invoiceRemainingAmount”
    }
  ],
  “select”: “SELECT ‘Legal Entity’
legalEntityHierarchydimensionDisplayName,PayablesBalance.legalEntityHierarchymember
Name legalEntityHierarchymemberName,PayablesBalance.legalEntityHierarchydepth
legalEntityHierarchydepth,‘Supplier’
supplierHierarchydimensionDisplayName,PayablesBalance.supplierHierarchysupplierName
supplierHierarchysupplierName,invoiceRemainingAmount FROM PayablesBalance
WHERE (((legalEntityHierarchydepth IN (1))) AND legalEntityHierarchylevelName NOT
IN ( ‘LEAF_NODE’ )) and legalEntityHierarchymemberName=‘BR123’”
}
```

### Example Results for Query on Aggregate Object

```
[
  {
    “legalEntityHierarchydimensionDisplayName”: “Legal Entity”,
    “legalEntityHierarchymemberName”: “BR123”,
    “legalEntityHierarchydepth”: 1,
    “supplierHierarchydimensionDisplayName”: “Supplier”,
    “supplierHierarchysupplierName”: “Brazil Unregistered Supplier”,
    “invoiceRemainingAmount”: 7839.43
  },
  {
    “legalEntityHierarchydimensionDisplayName”: “Legal Entity”,
    “legalEntityHierarchymemberName”: “BR123”,
    “legalEntityHierarchydepth”: 1,
    “supplierHierarchydimensionDisplayName”: “Supplier”,
    “supplierHierarchysupplierName”: “ACSYS Consultoria e Sistemas Ltda”,
    “invoiceRemainingAmount”: 49710
  },
  {
    “legalEntityHierarchydimensionDisplayName”: “Legal Entity”,
    “legalEntityHierarchymemberName”: “BR123”,
    “legalEntityHierarchydepth”: 1,
    “supplierHierarchydimensionDisplayName”: “Supplier”,
    “supplierHierarchysupplierName”: “Brazil Payment SSC Supplier”,
    “invoiceRemainingAmount”: 1000
  },
  {
    “legalEntityHierarchydimensionDisplayName”: “Legal Entity”,
    “legalEntityHierarchymemberName”: “BR123”,
    “legalEntityHierarchydepth”: 1,
    “supplierHierarchydimensionDisplayName”: “Supplier”,
    “supplierHierarchysupplierName”: “Eletropaulo Metropolitana Eletrecidade de Sao
Paulo S.A.”,
    “invoiceRemainingAmount”: 2000.34
  },
  {
    “legalEntityHierarchydimensionDisplayName”: “Legal Entity”,
    “legalEntityHierarchymemberName”: “BR123”,
    “legalEntityHierarchydepth”: 1,
    “supplierHierarchydimensionDisplayName”: “Supplier”,
    “supplierHierarchysupplierName”: “Fabrica de Ferramentas Ferraz Ltda”,
    “invoiceRemainingAmount”: 52131.76
  },
  {
    “legalEntityHierarchydimensionDisplayName”: “Legal Entity”,
    “legalEntityHierarchymemberName”: “BR123”,
    “legalEntityHierarchydepth”: 1,
    “supplierHierarchydimensionDisplayName”: “Supplier”,
    “supplierHierarchysupplierName”: “Elizabeth First”,
    “invoiceRemainingAmount”: 3000.56
  },
  {
    “legalEntityHierarchydimensionDisplayName”: “Legal Entity”,
    “legalEntityHierarchymemberName”: “BR123”,
    “legalEntityHierarchydepth”: 1,
    “supplierHierarchydimensionDisplayName”: “Supplier”,
    “supplierHierarchysupplierName”: “Eletropaulo Metropolitana Eletrecidade de Sao
Paulo S.A.”,
    “invoiceRemainingAmount”: 2000.34
  },
  {
    “legalEntityHierarchydimensionDisplayName”: “Legal Entity”,
    “legalEntityHierarchymemberName”: “BR123”,
    “legalEntityHierarchydepth”: 1,
    “supplierHierarchydimensionDisplayName”: “Supplier”,
    “supplierHierarchysupplierName”: “Fabrica de Ferramentas Ferraz Ltda”,
    “invoiceRemainingAmount”: 52131.76
  },
  {
    “legalEntityHierarchydimensionDisplayName”: “Legal Entity”,
    “legalEntityHierarchymemberName”: “BR123”,
    “legalEntityHierarchydepth”: 1,
    “supplierHierarchydimensionDisplayName”: “Supplier”,
    “supplierHierarchysupplierName”: “ACSYS Consultoria e Sistemas Ltda”,
    “invoiceRemainingAmount”: 49710
  },
  {
    “legalEntityHierarchydimensionDisplayName”: “Legal Entity”,
    “legalEntityHierarchymemberName”: “BR123”,
    “legalEntityHierarchydepth”: 1,
    “supplierHierarchydimensionDisplayName”: “Supplier”,
    “supplierHierarchysupplierName”: “Elizabeth First”,
    “invoiceRemainingAmount”: 3000.56
  },
  {
    “legalEntityHierarchydimensionDisplayName”: “Legal Entity”,
    “legalEntityHierarchymemberName”: “BR123”,
    “legalEntityHierarchydepth”: 1,
    “supplierHierarchydimensionDisplayName”: “Supplier”,
    “supplierHierarchysupplierName”: “Brazil Unregistered Supplier”,
    “invoiceRemainingAmount”: 7839.43
  },
  {
    “legalEntity HierarchydimensionDisplayName”: “Legal Entity”,
    “legalEntityHierarchymemberName”: “BR123”,
    “legalEntityHierarchydepth”: 1,
    “supplierHierarchydimensionDisplayName”: “Supplier”,
    “supplierHierarchysupplierName”: “Brazil Payment SSC Supplier”,
    “invoiceRemainingAmount”: 1000
  },
  {
    “legalEntityHierarchydimensionDisplayName”: “Legal Entity”,
    “legalEntityHierarchymemberName”: “BR123”,
    “legalEntityHierarchydepth”: 1,
    “supplierHierarchydimensionDisplayName”: “Supplier”,
    “supplierHierarchysupplierName”: null,
    “invoiceRemainingAmount”: 115682.09
  }
]
```

### Consumption Patterns

In various embodiments, RODS enables simplified, customized and adaptive data consumption based on consumption requirements. Examples of simplified, customized, and adaptive data consumption are provided below.
For an example of simplified data consumption, data consumption is through the standardized logical layer, thus eliminating the need for each consumer to understand intricacies of the physical data model and write/maintain complex SQLs. Instead the logical objects, which are generally consumed, may be prebuilt.
For an example of customized data consumption, data shapes can be customized to add filters as well as choose attributes from the pre-built logical/aggregate shapes.
For an example of adaptive data consumption, data can be consumed in real time (reporting/streaming) or in batches (for data extraction) on top of the same logical model.

### LLM Using RAG: Domain Clusters for Enabling Similarity Search

Large Language Models (LLM) are designed to understand context, infer meaning, and produce coherent and contextually relevant responses. However, they are trained on generic data. LLMs can be retrained on domain/company/organization specific data, but LLMs take significant computing resources to retrain. Also, retraining continuously to keep the model up to date is infeasible.

RAG (Retrieval-Augmented Generation) provides a way to optimize the output of an LLM with targeted information without modifying the underlying model itself; that targeted information can be more up-to-date than the LLM as well as specific to a particular organization and industry. That means the generative AI system can provide more contextually appropriate answers to prompts as well as base those answers on extremely current/accurate data.

Vectorization is the process of converting textual data into a numerical format that can be easily processed by machine learning models. For LLMs, vectorization translates words, sentences, and documents into vectors (arrays of numbers) that capture semantic meaning and context. A specialized database, such as Oracle vector database, provides built-in vectorization at scale, eliminating the need to transport out the vector data into a separate vector database (converged database strategy), enabling RODS to be leveraged for LLM-RAG usage.

Application-related domain knowledge helps LLMs to better understand user requests specific to the applications. This data can be grouped into domain clusters based on functional areas and vectorized, optionally using separate embedding models for different domains that best take advantage of the data variations applicable to those different domains. LLM-RAG can then leverage the domain clusters to better understand the intended meaning or even spelling similarity (auto correct) to better serve the end users.

To expand, domain clusters may capture the vector embeddings for key text columns belonging to specific logical shapes of each functional area. The proposed logical shapes to be included in each functional area are the ones that contain reference data rather than transactional data, meaning the logical shapes generally contributing to the dimensions of the aggregate shapes. The data in the reference logical shapes are referred by multiple transactions. For example, multiple payables invoices refer to the same supplier or same business unit. These vector embeddings of the supplier and/or business unit then assist with semantic/similarity search.

In one embodiment, the embedding model used for one or more first domain clusters is same or different than the embedding model used for one or more second domain clusters, such that different domain clusters may be vectorized using same or different embedding models that use same or different embedding spaces. For example, a finance-related domain cluster may use a finance-related embedding model that uses a finance-related embedding space, and a human capital management (HCM) domain cluster may use an HCM-related embedding model that uses an HCM-related embedding space.

FIG. 19 shows an example of a Payables Domain Cluster and some of the logical objects and the fields that may be vectorized for the Payables Domain.

LLM-RAG can then make use of semantic/similarity search to get the intended meaning of the user query. For example, a user query involving a search for invoices with supplier as “Advanced Network Devices” can be correctly interpreted as on supplier “Advanced Network Devices” using similarity/semantic search on payables domain cluster before forming the actual database query. As another example, a user query involving a search for invoices with supplier type as “Tax based” (not exact) can be correctly interpreted as on exact supplier type “Tax Authority” in the system (corrected) using semantic/similarity search on payables domain cluster before forming the actual database query.

### Leveraging ML for Various Customer Use Cases

The database may contain enterprise data related to customer's day to day transactions, often accumulated over many years. Each customer has specific set of business processes/practices, which are also reflected in the data. Analyzing this data can unlock opportunities for significant improvements in streamlining and automating business processes and enhance decision making. As this data gets synchronized to RODS, RODS can run read intensive ML algorithms on the data, without affecting the day to day transactional activity on the database.

In various example processes, ML helps streamline/automate the process.

For example, in Payables, importing invoices often results in frequent rejections because of missing attribute values. The rejections result in manual correction for pending invoices, depending on the invoicing channel of origin. Furthermore, active invoices frequently involve manual intervention post-import to update additional attributes, causing delays and increased workload for users. There is an opportunity for a more efficient system that can automatically assign values to various invoicing attributes based on user-defined defaulting rules, incorporating existing setup-based options, Optical Character Recognition tool configurations such as Intelligent Document Recognition (IDR), and transaction account defaulting.

The user-defined defaulting rules, can then be used as input during, before, and/or after the import invoices job is run, via standalone procedure named Rule-Driven Attribute Defaulting, to default various attributes as outlined herein. User defined rules and the associated Rule-Driven Attribute Defaulting may be generalized to work on any target object (in this case payables invoices).

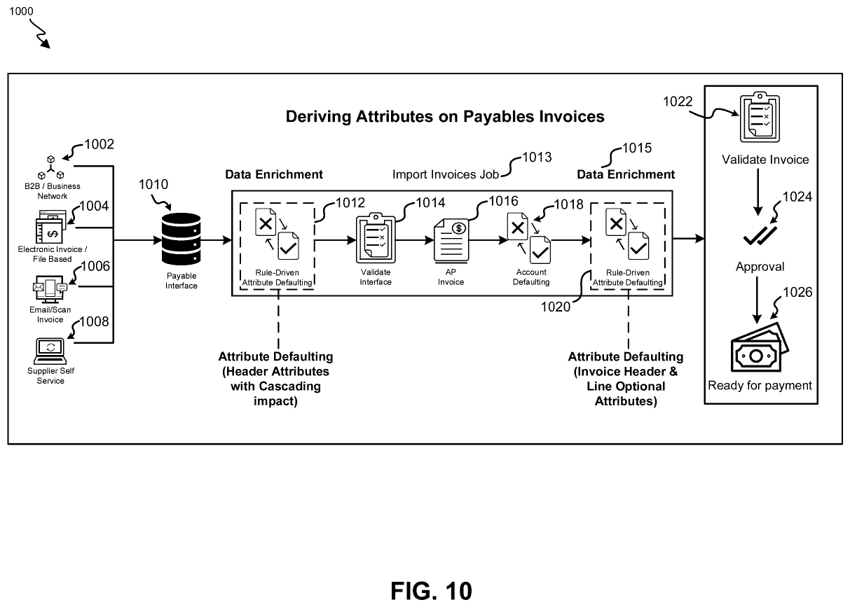

FIG. 10 shows an example of attribute defaulting using a user rule defined approach. Arriving at the defaulting rules may involve a deeper understanding of the business process/data and manual effort. In one embodiment, RODS can leverage ML to help customers by generating and/or guiding the generation of defaulting rules. RODS may use ML to help generate the defaulting rules and/or guide generation of the defaulting rules based on the existing historical data specific to customer, and the generated defaulted rules may be provided to user to review and approve. The autonomous generation of defaulting rules reduces the manual effort by the user to define/discover the rules from scratch while still providing control to end user on which rules to leverage. In a particular embodiment, Oracle ADW provides scalable in-database ML algorithms that may be used by RODS. In one example, RODS can leverage classification algorithms. Also, the logical shapes as defined earlier, may be used as input to get all “determinants” without needing to re-write joins/filters across multiple tables that have the data.

### Storing Built-In Prompt Metadata for Logical Objects in Rods

In various embodiments, RODS stores built-in prompt metadata, consumable by large language models and/or prompt generators to generate prompts or prompt metadata for instructing large language models to generate queries to perform operations on RODS. In this manner, as the logical structure schema and their logical object definitions in RODS changes, the prompt metadata consuming descriptions of the logical structure schema and their definitions automatically adapts to the changes by consuming the new logical structure schemas and new definitions without requiring a change to the prompt templates that are already dependent on RODS to produce the logical structure schemas and their definitions.

Example domain clusters show example consumable prompt metadata stored in RODS and available to prompt generators and/or LLMs. Example consumable prompt metadata includes any one or more of the following:
Key Entities, which identify primary entities of a product family, product or product area. Each entity may have a clear description as well as alternate names that are used across geographies, departments, etc.
Entity Types, which capture types or classifications for each entity along with applicable lookups that capture the classification.
Data Attributes, which capture key data attributes of each entity, the attribute description, default values, dependencies on other attributes, how the attribute is used as well as source of the attribute, if applicable.
Entity Relationships, which capture relationships including parent-child, dependencies or references among entities along with foreign keys/identifiers that capture the relationship.
Conditions, which capture additional logic based on entity-attribute values that determines key business functionality.
Other prompt metadata, which may also be consumable by LLMs.

Examples of domain-specific knowledge that may be supplied in alignment with different functional pathways may be stored in RODS based on functional pathways in the following example spaces, and any information provided in each of these spaces may be provided to an LLM in support of a prompt relevant to the corresponding space.

### Financial Domain Knowledge

Questions about financials typically involve different entities such as a Legal Entities, Business Units, Chart of Accounts, Calendar, Currencies, Ledgers which are used to segregate financial data. Each entity may have alternate representations or aliases. The alternate names or conventions are listed below and may additionally or alternatively be provided to an LLM or prompt generator as domain-specific data for inclusion in a prompt.
Legal Entity
   Alternate names: {Company, Corporation, or Enterprise}
Business Unit
   Alternate names: {Organization, Operating Unit, Department, or Division}
Chart of Account
   Alternate names: {Account structures}
Calendar
   Alternate names: {Accounting calendar}
Currency
   Alternate names: {Base Currency, Functional Currency}
   Related Contexts: {Foreign Currency, Conversion Type, Exchange Rate}
Ledger
   Alternate names: {Financial Ledger or Set of Books, or Primary Ledger} Account
   Alternate names: {Segments, Company, Natural Account, Product, Department, Sub-Account}

In financials contexts terms like YoY (Year over Year) etc. are used to compare financial data or performance between the one period and another period to identify trends, growth rates, and changes in metrics on a period basis. Some of the common comparison trends are as follows.

### Time Period Comparisons

```
{
  “time_period_comparisons”: [
    {
      “term”: “Day over Day”,
      “abbreviation”: “DoD”,
      “description”: “Compares data between the current day and the previous day.”
    },
    {
      “term”: “Week over Week”,
      “abbreviation”: “WOW”,
      “description”: “Measures performance between the current week and the previous week.”
    },
    {
      “term”: “Quarter over Quarter”,
      “abbreviation”: “QoQ”,
      “description”: “Assesses financial metrics between the current quarter and the previous
quarter.”
    },
    {
      “term”: “Year over Year”,
      “abbreviation”: “YoY”,
      “description”: “Evaluates data between the current year and the previous year.”
    },
    {
      “term”: “Month over Month”,
      “abbreviation”: “MOM”,
      “description”: “Examines changes between the current month and the preceding month.”
    },
    {
      “term”: “Rolling X over X”,
      “abbreviation”: “RxoX”,
      “description”: “Compares data over a rolling window of a specified period, such as
rolling 12 months over the previous 12 months.”
    },
    {
      “term”: “Half-Year over Half-Year”,
      “abbreviation”: “HyYoY”,
      “description”: “Compares the first half of the current year to the first half of the previous
year, and similarly for the second halves.”
    }
  ]
}
```

### Payables Domain Knowledge

Questions about Payables typically involve entities like Invoices, Suppliers, Holds, Tolerances on top of entities from Financials. Each entity may have alternate representations or aliases. The alternate names or conventions are listed below and may additionally or alternatively be provided to an LLM or prompt generator as domain-specific data for inclusion in a prompt.
Supplier
   Alternate names: {Vendor, Payee, Seller, Provider}
Invoice
   Alternate names: {Bill, Invoice, Memo or Payables Document}
Tolerance
   Alternate names: {Limit, Threshold, Deviation, Variance, Allowance} Budgetary Control
   Alternate names: {Funds check, Payment limits, Payment allowance}
Hold
   Alternate names: {Restriction, Constraint, Pre-Condition}

Invoice Types and related domain-specific data may be provided as:
INVOICE_TYPE_LOOKUP_CODE in AP_INVOICES_ALL identifies the invoice type, such as Standard, Credit memo, or Prepayment. Example values include: {“lookup_code”:“CREDIT”,“displayed_field”:“Credit memo”} {“lookup_code”:“DEBIT”,“displayed_field”:“Debit memo”} {“lookup_code”:“PAYMENT REQUEST”,“displayed_field”:“Payment request”} {“lookup_code”:“PREPAYMENT”,“displayed_field”:“Prepayment”} {“lookup_code”:“STANDARD”,“displayed_field”:“Standard”}
   Example payables invoices domain-specific data includes:
AP_INVOICES_ALL: This table contains records for all payables invoices.
   ORG_ID column stores the Business Unit
   VENDOR_ID column stores the Supplier
   VENDOR_SITE_ID column stores the Supplier Site
   TERMS_ID column stores the Chosen Payment Term
      Example prepayment domain-specific data includes:
Available Prepayment Invoices are Payable Invoices whose PREPAY_AMOUNT_REMAINING is not equal to 0.
Unapplied Prepayment Balances indicates how much of the prepayment is still available that can be applied to unpaid or partially paid invoices
   PREPAY_AMOUNT_REMAINING in table AP_INVOICE_DISTRIBUTIONS_ALL indicates the amount of prepayment that can still be applied to an invoice. This field will be 0 if no prepayment is left to be applied
   EARLIEST_SETTLEMENT_DATE in AP_INVOICES_ALL indicates the date associated with a prepayment after which it can be applied to an invoices. Only used for temporary prepayments. Column is null for permanent prepayments and other invoice types
   INVOICE_INCLUDES_PREPAY_FLAG in AP_INVOICE_DISTRIBUTIONS_ALL indicates whether prepayment amount is included in the invoice amount.
A prepayment can be applied only if it is temporary, paid, approved, not cancelled, has no active holds, and has not already been fully applied.
   CANCELLATION_FLAG in AP_INVOICE_DISTRIBUTIONS_ALL should be N
   APPROVAL_STATUS in AP_INVOICES_ALL should be APPROVED
   PAYMENT_STATUS_FLAG in AP_INVOICES_ALL should be Y (TBD)
   RELEASE_LOOKUP_CODE not null in AP_HOLDS_ALL for that Invoice
   PREPAY_AMOUNT_REMAINING in table AP_INVOICE_DISTRIBUTIONS_ALL not 0.

When a prepayment invoice is applied on a standard invoice, PREPAY_INVOICE_ID of AP_INVOICE_LINES_ALL table will have the prepayment invoice's ID populated. Also the invoice will be of type Standard

Example credit memos domain-specific data includes:
Credit Memos for Outstanding Invoices refers to a document issued by a seller (or vendor) that reduces the net amount a buyer owes on a specific invoice.
Credit Memos are invoices with negative INVOICE_AMOUNT in AP_INVOICES_ALL in general.
When a credit memo is matched to a standard invoice, PARENT_INVOICE_ID in AP_INVOICE_DISTRIBUTIONS_ALL contains the standard invoice id
   PARENT_INVOICE_ID Identifier for invoice matched to a credit or debit memo

Example Payables Holds domain-specific data includes:
AP_HOLDS_ALL: This table contains information about holds placed on an invoice.
   The HOLD_REASON column stores the reason for the hold.
   RELEASE_LOOKUP_CODE column indicates whether there is hold on the invoice or not
      Payables Hold Types: Holds prevent further processing of an Invoice or a Payment in the System. Holds can be System placed or user placed. System holds are released when the underlying business conditions is resolved. They can not be released by a Payables user.
AP_HOLD_CODES: This table contains information about different type of holds and whether they are releasable or not.
   USER RELEASABLE FLAG column indicates whether the hold is releasable
   Example values include: {“hold_type”:“ACCT HOLD REASON”,“lookup_code”:“AWT ACCT INVALID”,“displayed_field”:“Withholding tax account invalid”} {“hold_type”:“ACCT HOLD REASON”,“lookup_code”:“LIAB ACCT INVALID”,“displayed_field”:“Liability account invalid”} {“hold_type”:“ACCT HOLD REASON”,“lookup_code”:“ERV ACCT INVALID”,“displayed_field”:“Conversion rate variance account invalid”} {“hold_type”:“ACCT HOLD REASON”,“lookup_code”:“DIST ACCT INVALID”,“displayed_field”:“Distribution combination invalid”} {“hold_type”:“FUNDS HOLD REASON”,“lookup_code”:“ORA_FUNDS RESERVE FAIL”,“displayed_field”:“Funds reservation failed”} {“hold_type”:“FUNDS HOLD REASON”,“lookup_code”:“ORA_CANT CALC BURDEN COST”,“displayed_field”:“Cannot calculate burden cost”} {“hold_type”:“FUNDS HOLD REASON”,“lookup_code”:“CANT FUNDS CHECK”,“displayed_field”:“Funds check”} {“hold_type”:“FUNDS HOLD REASON”,“lookup_code”:“INSUFFICIENT FUNDS”,“displayed_field”:“Insufficient funds”} {“hold_type”:“INVOICE HOLD REASON”,“lookup_code”:“AWT ERROR”,“displayed_field”:“Withholding tax”} {“hold_type”:“INVOICE HOLD REASON”,“lookup_code”:“ORA_TAX_CALCULATION”,“displayed_field”:“Tax Calculation”} {“hold_type”:“INVOICE HOLD REASON”,“lookup_code”:“SUP/MGR Hold”,“displayed_field”:“Workflow process”} {“hold_type”:“INVOICE HOLD REASON”,“lookup_code”:“ORA_NO TAX ON RECEIPT”,“displayed_field”:“Matched receipt or consumption advice not accounted”} {“hold_type”:“INVOICE HOLD REASON”,“lookup_code”:“ORA_FV_TAS_BETC_HOLD”,“displayed_field”:“TAS BETC Validation for US Federals”} {“hold_type”:“INVOICE HOLD REASON”,“lookup_code”:“INCOMPLETE INVOICE”,“displayed_field”:“Incomplete invoice”} {“hold_type”:“INVOICE HOLD REASON”,“lookup_code”:“ORA_FV_PREPAYMENT_HOLD”,“displayed_field”:“Prepayment PO Required for US Federals”} {“hold_type”:“INVOICE HOLD REASON”,“lookup_code”:“ORA_AP_BANK_ACK_RJCT”,“displayed_field”:“Acknowledgment rejection”} {“hold_type”:“INVOICE HOLD REASON”,“lookup_code”:“ORA_TAX_DIST_GENERATION”,“displayed_field”:“Tax Distribution Generation”} {“hold_type”:“INVOICE HOLD REASON”,“lookup_code”:“ORA_TAX_INV_NOT_EXISTS”,“displayed_field”:“Missing tax invoice number”} {“hold_type”:“INVOICE HOLD REASON”,“lookup_code”:“ORA_FV_ACCOUNTING_HOLD”,“displayed_field”:“Invalid Accounting Setup for US Federals”} {“hold_type”:“INVOICE HOLD REASON”,“lookup_code”:“NATURAL ACCOUNT TAX”,“displayed_field”:“Natural account tax”} {“hold_type”:“INVOICE HOLD REASON”,“lookup_code”:“ORA_FV_EXPIRED_TAS_HOLD”,“displayed_field”:“Expired TAS for US Federals”} {“hold_type”:“LINE HOLD REASON”,“lookup_code”:“LINE VARIANCE”,“displayed_field”:“Line variance”} {“hold_type”:“LINE HOLD REASON”,“lookup_code”:“INSUFFICIENT LINE INFO”,“displayed_field”:“Cannot generate distributions”} {“hold_type”:“LINE HOLD REASON”,“lookup_code”:“DISTRIBUTION SET INACTIVE”,“displayed_field”:“Inactive distribution set”} {“hold_type”:“LINE HOLD REASON”,“lookup_code”:“CANNOT OVERLAY ACCOUNT”,“displayed_field”:“Cannot overlay account”} {“hold_type”:“LINE HOLD REASON”,“lookup_code”:“CANNOT EXECUTE ALLOCATION”,“displayed_field”:“Cannot execute allocation”} {“hold_type”:“LINE HOLD REASON”,“lookup_code”:“AP PJC VALIDATION FAILED”,“displayed_field”:“Projects cost validation failure”} {“hold_type”:“LINE HOLD REASON”,“lookup_code”:“INVALID DEFAULT ACCOUNT”,“displayed_field”:“Invalid default distribution combination”} {“hold_type”:“LINE HOLD REASON”,“lookup_code”:“SKELETON DISTRIBUTION SET”,“displayed_field”:“Skeleton distribution set”} {“hold_type”:“MATCHING HOLD REASON”,“lookup_code”:“FINAL MATCHING”,“displayed_field”:“Final matching”} {“hold_type”:“MATCHING HOLD REASON”,“lookup_code”:“CANT TRY PO CLOSE”,“displayed_field”:“Cannot try PO close”} {“hold_type”:“MATCHING HOLD REASON”,“lookup_code”:“MILESTONE”,“displayed_field”:“Milestone”} {“hold_type”:“PERIOD HOLD TYPE”,“lookup_code”:“FUTURE PERIOD”,“displayed_field”:“Future period”} {“hold_type”:“PERIOD HOLD TYPE”,“lookup_code”:“CLOSED PERIOD”,“displayed_field”:“Closed period”} {“hold_type”:“VARIANCE HOLD REASON”,“lookup_code”:“DIST VARIANCE”,“displayed_field”:“Distribution variance”} {“hold_type”:“VARIANCE HOLD REASON”,“lookup_code”:“PREPAID AMOUNT”,“displayed_field”:“Prepaid amount”} {“hold_type”:“VARIANCE HOLD REASON”,“lookup_code”:“INSTALLMENT VARIANCE”,“displayed_field”:“Installment variance”}
      Example payment terms include:
AP_TERMS_LINES: This table stores information about the payment terms associated with invoices.
   The DISCOUNT_PERCENT and DISCOUNT_DAYS columns indicate that a discount is available for early invoice payment.

### Payables Payments Domain Knowledge

Questions about Payments or Disbursements typically involve entities such as a Discounts, Payment Methods, Documents Payable or Invoices and Bank Accounts on top of Payables and Financial entities. Each entity may have alternate representations or aliases. The alternate names or conventions are listed below and may additionally or alternatively be provided to an LLM or prompt generator as domain-specific data for inclusion in a prompt.
Payment
   Alternate names: {Disbursement, Funds delivery, Funding}
Discounts
   Alternate names: {Rebates, Credits, or Early Payment Incentives}
Payment Schedules
   Alternate names: {Payment Installments}
Payment Methods
   Alternate names: {Payment Disbursement Methods}
   Example values include: {“lookup_code”:“CHECK”,“meaning”:“Check Payment”} {“lookup_code”:“CLEARING”,“meaning”:“Payment Clearing”} {“lookup_code”:“EFT”,“meaning”:“Electronic Payment”} {“lookup_code”:“WIRE”,“meaning”:“Wire Payment”}
Payment Status: <description>
   Alternate names: {Paid Status}
   Example values include: [{“lookup_code”:“N”,“displayed_field”:“Not paid”} {“lookup_code”:“P”,“displayed_field”:“Partially paid”} {“lookup_code”:“Y”,“displayed_field”:“Fully paid”}]
      Example Payment Schedules domain-specific data includes:
AP_PAYMENT_SCHEDULES_ALL: This table contains information about scheduled payments for an invoice.
   The HOLD FLAG will be set to ‘Y’ if a hold is placed on the scheduled payment, indicating that the invoice is not ready for payment, and ‘N’ otherwise.
      Example Payment Status domain-specific data includes:
PAYMENT_STATUS_FLAG in AP_INVOICES_ALL is the flag that indicates the payment status of an invoice:
   Example values include: [{“lookup_code”:“N”,“displayed_field”:“Not paid”} {“lookup_code”:“P”,“displayed_field”:“Partially paid”} {“lookup_code”:“Y”,“displayed_field”:“Fully paid”}]
      Example Payments domain-specific data includes:
AP_CHECKS_ALL: This table contains records for all the payables payments.
   Value in PAYMENT_METHOD_CODE column indicates the payment method
   Example values include: {“lookup_code”:“CHECK”,“meaning”:“Check Payment”} {“lookup_code”:“CLEARING”,“meaning”:“Payment Clearing”} {“lookup_code”:“EFT”,“meaning”:“Electronic Payment”} {“lookup_code”:“WIRE”,“meaning”:“Wire Payment”}
Value in STATUS_LOOKUP_CODE column indicates the status of a payment. Example values include: {“lookup_code”:“CLEARED”,“displayed_field”:“Cleared”} {“lookup_code”:“CLEARED BUT UNACCOUNTED”,“displayed_field”:“Cleared but unaccounted”} {“lookup_code”:“ISSUED”,“displayed_field”:“Issued”} {“lookup_code”:“NEGOTIABLE”,“displayed_field”:“Negotiable”} {“lookup_code”:“ORA_ESCHEATED”,“displayed_field”:“Escheated”} {“lookup_code”:“ORA_ESCHEATMENT_INITIATED”,“displayed_field”:“Escheatment Initiated”} {“lookup_code”:“ORA_ESCHEATMENT_INPROGRESS”,“displayed_field”:“Obsolete: Escheatment In Progress”} {“lookup_code”:“ORA_ESCHEAT_INPROGRESS”,“displayed_field”:“Selected for Escheatment”} {“lookup_code”:“OVERFLOW”,“displayed_field”:“Overflow”} {“lookup_code”:“RECONCILED”,“displayed_field”:“Reconciled”} {“lookup_code”:“RECONCILED UNACCOUNTED”,“displayed_field”:“Reconciled unaccounted”} {“lookup_code”:“SET UP”,“displayed_field”:“Setup”} {“lookup_code”:“SPOILED”,“displayed_field”:“Spoiled”} {“lookup_code”:“STOP INITIATED”,“displayed_field”:“Stop initiated”} {“lookup_code”:“UNCONFIRMED SET UP”,“displayed_field”:“Unconfirmed setup”} {“lookup_code”:“VOIDED”,“displayed_field”:“Voided”}

### Use of Large Language Model and Machine Learning Features

Domain clusters enable similarity search with incoming data to different domains to determine a functional area relevant to the incoming data. The domain clusters may have corresponding pre-computed vector embeddings such that vector embeddings of inputs can be compared in terms of cosine similarity to the vector embeddings of the domain clusters to efficiently determine which functional area a natural language query may involve. Information about the corresponding functional area may be embedded in a prompt template to promote efficient use of the logical objects along the corresponding functional areas.

Large Language Models (LLM) are designed to understand context, infer meaning, and produce coherent and contextually relevant responses. However, they are trained on generic data. LLMs can be guided using few shot examples on domain/company/organization specific data. RAG (Retrieval-Augmented Generation) provides a way to optimize the output of an LLM with targeted information without modifying the underlying model itself, that targeted information can be more up-to-date than the LLM as well as specific to a particular organization and industry. That means the generative AI system can provide more contextually appropriate answers to prompts as well as base those answers on current/accurate data.

Vectorization is the process of converting textual data into a numerical format that can be easily processed by machine learning models. For LLMs, vectorization translates words, sentences, and documents into vectors (arrays of numbers) that capture semantic meaning and context. Oracle DB provides in house vectorization at scale, eliminating the need to transport out the vector data into a separate vector database (converged database strategy), enabling RODS to be leveraged for LLM-RAG usage.

Applications related domain knowledge is used in prompt templates to help LLMs better understand user requests specific to or native to applications in use. This data can be grouped into domain clusters based on functional areas and vectorized. LLM-RAG can then leverage the domain clusters to better understand the intended meaning or even spelling similarity (e.g., auto correct) to better serve the end users.

The database contains enterprise data related to customer's data to day transactions, often accumulated over many years. Each customer has a specific set of business processes/practices, which are also reflected in the data. Analyzing this data can unlock opportunities for significant improvements in streamlining and automating business processes and enhance decision making. As this data gets synchronized to RODS, RODS can run read intensive ML algorithms on the data without affecting the day to day transactional activity on the database.

### Configuring and Deploying User-Defined Defaulting Rules for Operations

FIG. 1B illustrates a flow chart of an example attribute defaulting configuration and process. In block 122, a data management system causes display of a configuration interface that provides a first option for treating missing values of a particular type of data item and a second option for treating missing values of another particular type of data item. In block 124, the data management system receives, via the configuration interface, a user-specific setting for a user that specifies the particular type of data item and not the other particular type of data item is to have the missing values predicted by a machine learning model. In block 126, the data management system trains a machine learning model to predict values for at least one field of the particular type of data item. The machine learning model is trained on a plurality of historical instances of the particular type of data where a value for the at least one field is not missing. In block 128, the data management system receives a request to retrieve data for the user. In block 130, responsive to the request, the data management system determines a result including one or more particular data items that include one or more missing values. The one or more particular data items are of the particular type of data item. In block 132, based at least in part on the user-specific setting, the data management system replaces at least one of the one or more missing values with a particular predicted value determined from the machine learning model. In block 134, the data management system returns the one or more particular data items as if the particular predicted value was part of the one or more particular data items when the request was received, optionally without updating the one or more particular data items as stored in an underlying database. For example, the particular data items as stored in the database may be requested or used to satisfy one or more other requests, in which case the one or more missing values (rather than the particular predicted value) may be returned as part of the particular data items, and/or another particular predicted value may be returned as part of the particular data items. The other particular predicted value may be different than the particular predicted value, as the machine learning model may be configured to generate a new prediction that may account for changed circumstances or updated random variation that is different when processing the one or more other requests than was determined when processing prior request(s).

In various embodiments, a data management system may determine a missing value for a record and use the missing value to carry out an operation. The process of determining and filling in missing values may be controlled by user-defined defaulting rules that guide whether blank or missing values are predicted by the system when the system returns other non-blank or non-missing values for certain types of objects. The user may specify under what conditions or for which objects default values should be predicted and what other conditions blank or missing values should be returned as-is without prediction.

In one example, for Payables, importing invoices often results in frequent rejections because of missing attribute values. Importing invoices may then involve manual correction for pending invoices, depending on the invoicing channel of origin. Furthermore, active invoices frequently receive manual intervention post-import to update additional attributes, causing delays and increased workload for users. There is an opportunity for a more efficient system that can automatically assign values to various invoicing attributes based on user-defined defaulting rules, incorporating existing setup-based options, Optical Character Recognition tool configurations such as Intelligent Document Recognition (IDR), and/or transaction account defaulting.

The user-defined defaulting rules can then be used as input during/before/after the import invoices job is run, via standalone procedure named Rule-Driven Attribute Defaulting, to default the attributes as outlined below. User defined rules and the associated Rule-Driven Attribute Defaulting are generalized to work on any target object (in this case payables invoices).

FIG. 10 shows an example approach 1000 of attribute defaulting using user-defined rules. As shown, rule-driven attribute defaulting 1012 uses a validate interface 1014 to determine an accounts payable invoice 1016, which may then use account defaulting 1018 and rule-driven attribute defaulting 1020 according to stored settings. The invoice goes from a validation stage 1022 to an approval stage 1024 and advances to a ready for payment stage 1026. Such data may be consumed by B2B business network 1002, electronic invoice or file-based system 1004, email/scan invoice service 1006, and supplier self service 1008 via a payable interface 1010.

Arriving at the defaulting rules may involve a deeper understanding of the business process/data and manual effort. In one embodiment, ML helps generate the defaulting rules based on the existing historical data specific to the customer, and the generated defaulted rules are provided to the user to review and approve. This reduces the manual effort by the user to define/discover the rules from scratch as well as to provide control to end user on which rules to leverage. Databases such as Oracle ADW provides scalable in-database ML algorithms, including classification algorithms. The logical shapes are used as input to get all “determinants” without re-writing joins/filters across multiple underlying tables that store the underlying data.

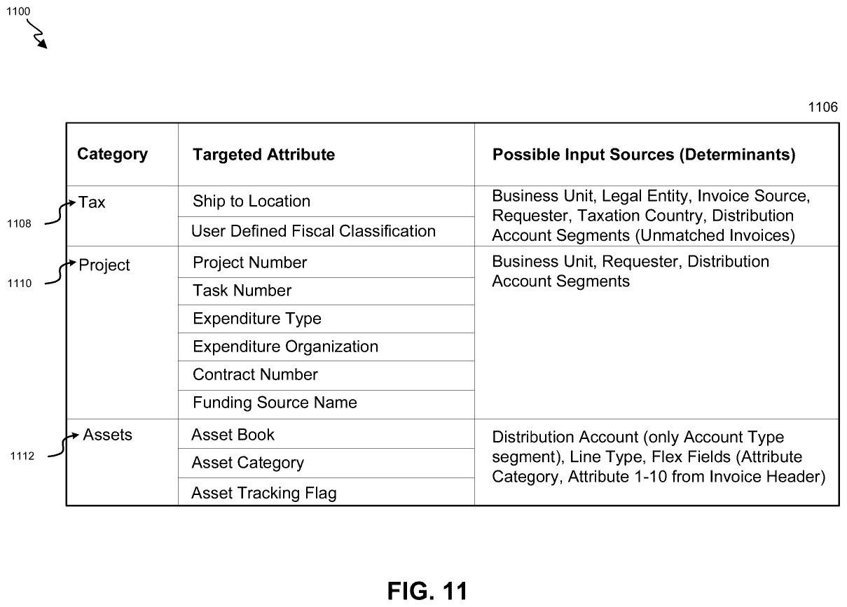

FIG. 11 shows an example table 1100 of invoice attribute categories 1108, 1110, and 1112 that can be determined based on specific determinants (source attributes) from historical data specific to the customer. The possible input sources may be used by a machine learning model as features to determine most frequent values that were used for the target attribute when similar combinations of input values occurred in the past.

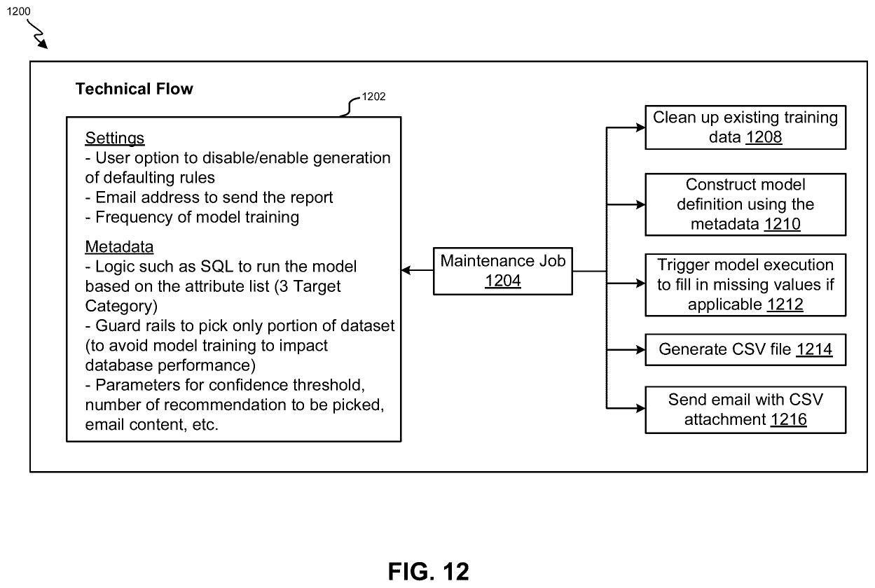

FIG. 12 shows an example overall flow 1200 for running machine learning on data and sending potential defaulting rules to a user for review. Upon approval, these rules can be leveraged in flows such as Import Invoices, as data from the database can be read through RODS with defaulting rules configured so that missing values are automatically filled in by RODS when the read data is returned.

As shown in FIG. 12, flow 1200 includes a maintenance job 1204 or another sub-process that determines training data in block 1208 and uses the training data to construct a model based on the metadata in block 1210. The model may be used to predict the missing value, if applicable, in block 1212, and the missing value may be returned in any format used to support the process, such as the CSV file generated in block 1214. To facilitate user review of predictions, the CSV file may be emailed to a supervising user as a CSV attachment in block 1216. Once the model is constructed based on the defaulting rule, missing values may be returned for similar objects without rebuilding the model. In various embodiments, the model may be periodically retrained based on new data to remain up-to-date.

As shown in block 1202, settings include a user option to disable/enable generation of defaulting rules, an email address may be provided for sending a report for user feedback, and a frequency of model training may be selected for updating the model and/or obtaining updated user feedback. Metadata may be specified such as logic to run the model based on an attribute list, target categories, or a portion of a dataset that is available to use for defaulting rules, and parameters to use for the confidence threshold, a number of recommendations to be picked, email content, etc.

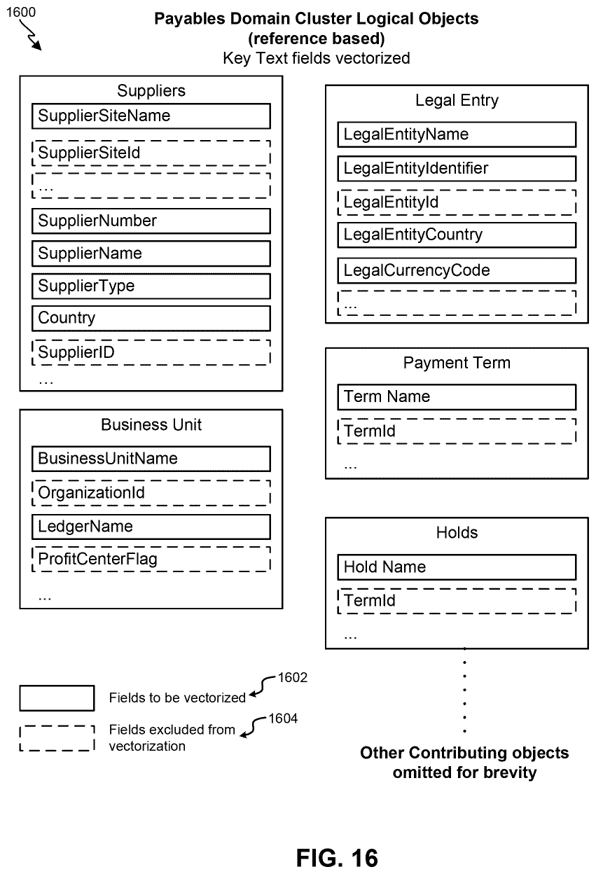

FIG. 16 shows example fields 1600 of a payables domain cluster and some of the logical objects and the fields to be vectorized. In the example, fields to be vectorized 1602 are shown with solid lines, and fields excluded from vectorization 1604 are shown in dashed lines. By excluding some fields from vectorization, the system may maintain high performance for the fields that are vectorized. The fields that are vectorized may be selected as those fields that are most likely to be used as a filtering fields, search fields, or as the source of content-driven inquiries, as opposed to fields that store IDs, binary values, and/or other values that do not have a commonly understood semantic meaning outside of the database schema to support meaningful vectorization. Excluding such fields focuses vectorization and similarity measurements on those fields where similarity of vectors is likely to lead to similarity in content, such as names, entity types, countries, and/or textual descriptions.

### Access to Aggregate Objects Via Rest

In various examples, RODS, and, in particular, aggregate objects exposed by RODS, are accessible via REST such that requests may be sent and responses received by consumers of the REST service, optionally specific to a functional area. An example REST request on the payables balance aggregate shape to aggregate payables balance by all suppliers for a specific legal entity has been provided herein as “Example REST request on Payables Balance Aggregate object,” and an example result of the request has been provided herein as “Example Results for query on aggregate object.”

### Agent-Based Architecture to Provide Data Management Services

In various embodiments, consuming services may be configured to interact with a read-optimized data service for particular purposes according to preconfigured logic. In some embodiments, different services consuming or instantiating a read-optimized data service may be different agent instances that are preconfigured to have same or different tools (e.g., with different APIs available to use and/or with same or different authentication keys to authenticate with the same or different APIs) available to access different datasets, or same datasets optionally with different privileges or roles, or perform same or different operations or same or different sequences of operations, or with same or different functional capabilities or specialties, optionally with access to a large language model for supporting deeper inquiries that use data provided to the large language model as well as the large language model's general knowledge. For example, a finance-related agent instance may be preconfigured to address finance-related issues optionally with access to other finance-related tools, and an HR-related agent instance may be preconfigured to address HR-related issues optionally with access to other HR-related tools. The agents may communicate with each other and/or with an orchestrating agent that is configured to address questions, queries, or issues potentially involving a variety of topics, different parts of which may be assigned to different agents that are specialized or otherwise designated to handle corresponding topics.

In various embodiments, the data stored in and served by the read-optimized data service may be vectorized and used for various LLM use cases and/or search use cases. The data stored in the read-optimized data service may be used by different functional agents across a software platform such as an enterprise resource planning (ERP) software or other enterprise software platform to serve as a tool for Retrieval Augmented Generation (RAG).

### Computer System Architecture

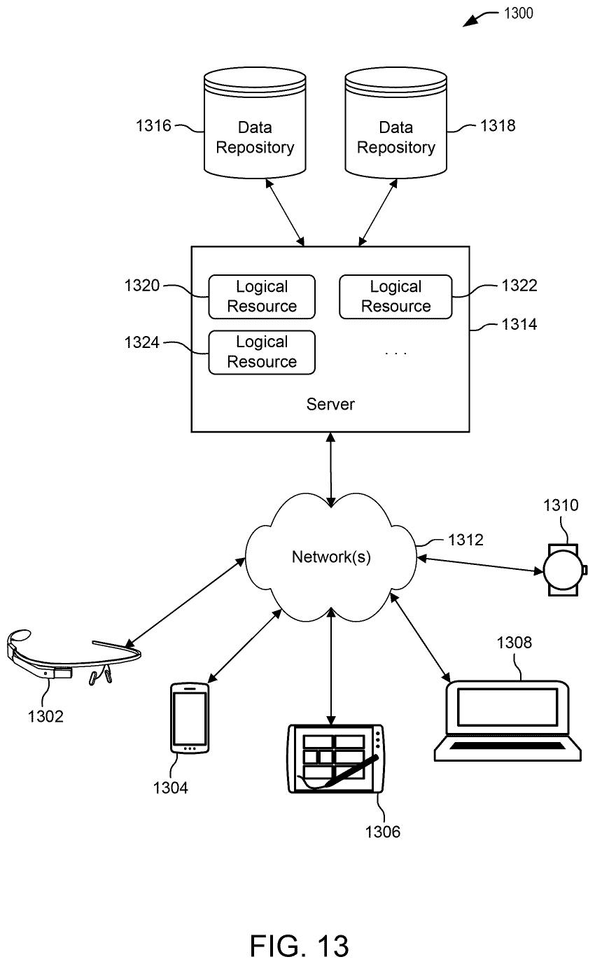

FIG. 13 depicts a simplified diagram of a distributed system 1300 for implementing an embodiment. In the illustrated embodiment, distributed system 1300 includes one or more client computing devices 1302, 1304, 1306, 1308, and/or 1310 coupled to a server 1314 via one or more communication networks 1312. Clients computing devices 1302, 1304, 1306, 1308, and/or 1310 may be configured to execute one or more applications.

In various aspects, server 1314 may be adapted to run one or more services or software applications that enable techniques for using a read-optimized data management service to access objects without exposing underlying database structures or other pathways.

In certain aspects, server 1314 may also provide other services or software applications that can include non-virtual and virtual environments. In some aspects, these services may be offered as web-based or cloud services, such as under a Software as a Service (SaaS) model to the users of client computing devices 1302, 1304, 1306, 1308, and/or 1310. Users operating client computing devices 1302, 1304, 1306, 1308, and/or 1310 may in turn utilize one or more client applications to interact with server 1314 to utilize the services provided by these components.

In the configuration depicted in FIG. 13, server 1314 may include one or more components 1320, 1322 and 1324 that implement the functions performed by server 1314. These components may include software components that may be executed by one or more processors, hardware components, or combinations thereof. It should be appreciated that various different system configurations are possible, which may be different from distributed system 1300. The embodiment shown in FIG. 13 is thus one example of a distributed system for implementing an embodiment system and is not intended to be limiting.

Users may use client computing devices 1302, 1304, 1306, 1308, and/or 1310 for techniques for using a read-optimized data management service to access objects without exposing underlying database structures or other pathways in accordance with the teachings of this disclosure. A client device may provide an interface that enables a user of the client device to interact with the client device. The client device may also output information to the user via this interface. Although FIG. 13 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google® Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various different applications such as various Internet-related apps, communication applications (e.g., e-mail applications, short message service (SMS) applications) and may use various communication protocols.

Network(s) 1312 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 1312 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 1314 may be composed of one or more general purpose computers, specialized server computers (including, by way of example, PC (personal computer) servers, UNIX® servers, LINUX® servers, mid-range servers, mainframe computers, rack-mounted servers, etc.), server farms, server clusters, a Real Application Cluster (RAC), database servers, or any other appropriate arrangement and/or combination. Server 1314 can include one or more virtual machines running virtual operating systems, or other computing architectures involving virtualization such as one or more flexible pools of logical storage devices that can be virtualized to maintain virtual storage devices for the server. In various aspects, server 1314 may be adapted to run one or more services or software applications that provide the functionality described in the foregoing disclosure.

The computing systems in server 1314 may run one or more operating systems including any of those discussed above, as well as any commercially available server operating system. Server 1314 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 1314 may include one or more applications to analyze and consolidate data feeds and/or event updates received from users of client computing devices 1302, 1304, 1306, 1308, and/or 1310. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 1314 may also include one or more applications to display the data feeds and/or real-time events via one or more display devices of client computing devices 1302, 1304, 1306, 1308, and/or 1310.

Distributed system 1300 may also include one or more data repositories 1316, 1318. These data repositories may be used to store data and other information in certain aspects. For example, one or more of the data repositories 1316, 1318 may be used to store information for techniques for using a read-optimized data management service to access objects without exposing underlying database structures or other pathways. Data repositories 1316, 1318 may reside in a variety of locations. For example, a data repository used by server 1314 may be local to server 1314 or may be remote from server 1314 and in communication with server 1314 via a network-based or dedicated connection. Data repositories 1316, 1318 may be of different types. In certain aspects, a data repository used by server 1314 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 1316, 1318 may also be used by applications to store application data. The data repositories used by applications may be of different types such as, for example, a key-value store repository, an object store repository, or a general storage repository supported by a file system.

In one embodiment, server 1314 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

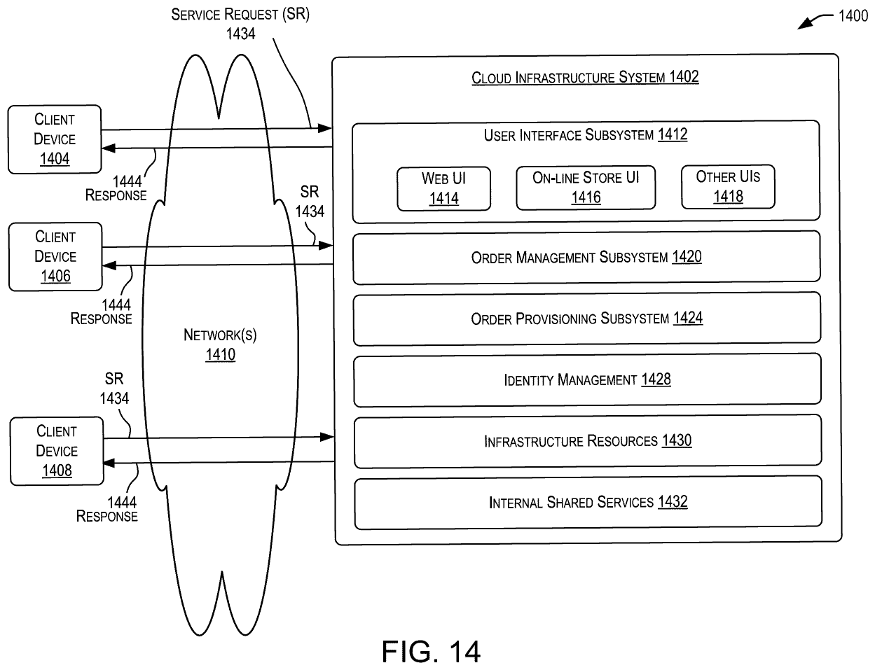

FIG. 14 is a simplified block diagram of a cloud-based system environment in which use a read-optimized data management service to access objects without exposing underlying database structures or other pathways, in accordance with certain aspects. In the embodiment depicted in FIG. 14, cloud infrastructure system 1402 may provide one or more cloud services that may be requested by users using one or more client computing devices 1404, 1406, and 1408. Cloud infrastructure system 1402 may comprise one or more computers and/or servers that may include those described above for server 1314. The computers in cloud infrastructure system 1402 may be organized as general purpose computers, specialized server computers, server farms, server clusters, or any other appropriate arrangement and/or combination.

Network(s) 1410 may facilitate communication and exchange of data between clients 1404, 1406, and 1408 and cloud infrastructure system 1402. Network(s) 1410 may include one or more networks. The networks may be of the same or different types. Network(s) 1410 may support one or more communication protocols, including wired and/or wireless protocols, for facilitating the communications.

The embodiment depicted in FIG. 14 is only one example of a cloud infrastructure system and is not intended to be limiting. It should be appreciated that, in some other aspects, cloud infrastructure system 1402 may have more or fewer components than those depicted in FIG. 14, may combine two or more components, or may have a different configuration or arrangement of components. For example, although FIG. 14 depicts three client computing devices, any number of client computing devices may be supported in alternative aspects.

The term cloud service is generally used to refer to a service that is made available to users on demand and via a communication network such as the Internet by systems (e.g., cloud infrastructure system 1402) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 1410 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 1402 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 1402 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 1402. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 1402. Cloud infrastructure system 1402 then performs processing to provide the services requested in the tenant's subscription order. Cloud infrastructure system 1402 may be configured to provide one or even multiple cloud services.

Cloud infrastructure system 1402 may provide the cloud services via different deployment models. In a public cloud model, cloud infrastructure system 1402 may be owned by a third party cloud services provider and the cloud services are offered to any general public tenant, where the tenant can be an individual or an enterprise. In certain other aspects, under a private cloud model, cloud infrastructure system 1402 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 1402 and the services provided may be shared by several organizations in a related community. Various other models such as hybrids of the above mentioned models may also be used.

Client computing devices 1404, 1406, and 1408 may be of different types (such as devices 1302, 1304, 1306, and 1308 depicted in FIG. 13) and may be capable of operating one or more client applications. A user may use a client device to interact with cloud infrastructure system 1402, such as to request a service provided by cloud infrastructure system 1402.

In some aspects, the processing performed by cloud infrastructure system 1402 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 1402 for determining the intent of an utterance. The data used for this analysis may include structured data (e.g., data stored in a database or structured according to a structured model) and/or unstructured data (e.g., data blobs (binary large objects)).

As depicted in the embodiment in FIG. 14, cloud infrastructure system 1402 may include infrastructure resources 1430 that are utilized for facilitating the provision of various cloud services offered by cloud infrastructure system 1402. Infrastructure resources 1430 may include, for example, processing resources, storage or memory resources, networking resources, and the like.

In certain aspects, to facilitate efficient provisioning of these resources for supporting the various cloud services provided by cloud infrastructure system 1402 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 1402 may itself internally use services 1432 that are shared by different components of cloud infrastructure system 1402 and which facilitate the provisioning of services by cloud infrastructure system 1402. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 1402 may comprise multiple subsystems. These subsystems may be implemented in software, or hardware, or combinations thereof. As depicted in FIG. 14, the subsystems may include a user interface subsystem 1412 that enables users of cloud infrastructure system 1402 to interact with cloud infrastructure system 1402. User interface subsystem 1412 may include various different interfaces such as a web interface 1414, an online store interface 1416 where cloud services provided by cloud infrastructure system 1402 are advertised and are purchasable by a consumer, and other interfaces 1418. For example, a tenant may, using a client device, request (service request 1434) one or more services provided by cloud infrastructure system 1402 using one or more of interfaces 1414, 1416, and 1418. For example, a tenant may access the online store, browse cloud services offered by cloud infrastructure system 1402, and place a subscription order for one or more services offered by cloud infrastructure system 1402 that the tenant wishes to subscribe to. The service request may include information identifying the tenant and one or more services that the tenant desires to subscribe to. For example, a tenant may place a subscription order for a chatbot related service offered by cloud infrastructure system 1402. As part of the order, the client may provide information identifying the input (e.g. utterances).

In certain aspects, such as the embodiment depicted in FIG. 14, cloud infrastructure system 1402 may comprise an order management subsystem (OMS) 1420 that is configured to process the new order. As part of this processing, OMS 1420 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 1420 may then invoke the order provisioning subsystem (OPS) 1424 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 1424 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 1402 may send a response or notification 1444 to the requesting tenant to indicate when the requested service is now ready for use. In some instances, information (e.g., a link) may be sent to the tenant that enables the tenant to start using and availing the benefits of the requested services.

Cloud infrastructure system 1402 may provide services to multiple tenants. For each tenant, cloud infrastructure system 1402 is responsible for managing information related to one or more subscription orders received from the tenant, maintaining tenant data related to the orders, and providing the requested services to the tenant or clients of the tenant. Cloud infrastructure system 1402 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 1402 may provide services to multiple tenants in parallel. Cloud infrastructure system 1402 may store information for these tenants, including possibly proprietary information. In certain aspects, cloud infrastructure system 1402 comprises an identity management subsystem (IMS) 1428 that is configured to manage tenant's information and provide the separation of the managed information such that information related to one tenant is not accessible by another tenant. IMS 1428 may be configured to provide various security-related services such as identity services, such as information access management, authentication and authorization services, services for managing tenant identities and roles and related capabilities, and the like.

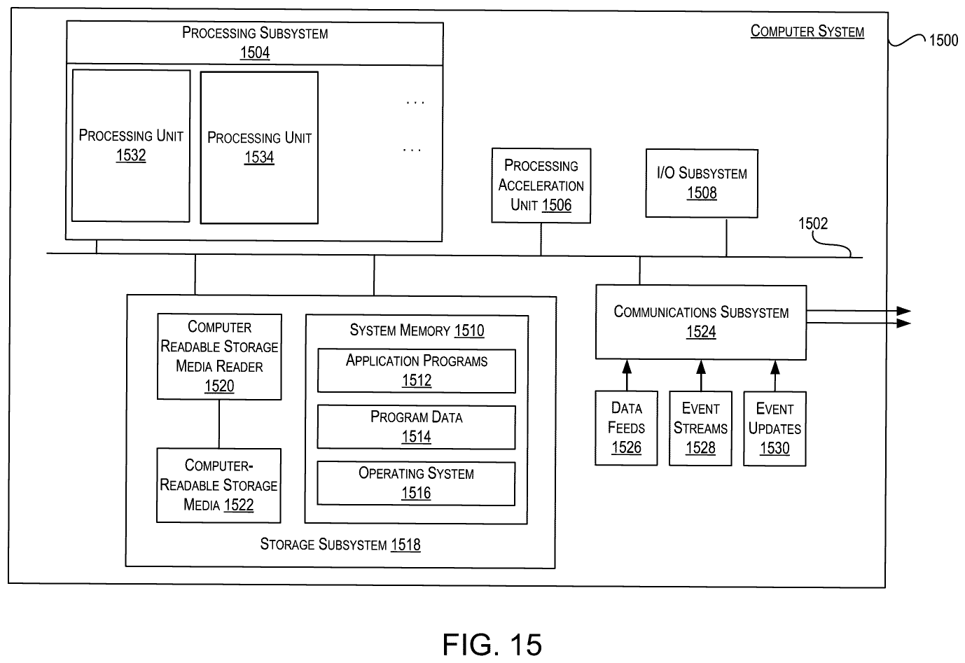

FIG. 15 illustrates an exemplary computer system 1500 that may be used to implement certain aspects. As shown in FIG. 15, computer system 1500 includes various subsystems including a processing subsystem 1504 that communicates with a number of other subsystems via a bus subsystem 1502. These other subsystems may include a processing acceleration unit 1506, an I/O subsystem 1508, a storage subsystem 1518, and a communications subsystem 1524. Storage subsystem 1518 may include non-transitory computer-readable storage media including storage media 1522 and a system memory 1510.

Bus subsystem 1502 provides a mechanism for letting the various components and subsystems of computer system 1500 communicate with each other as intended. Although bus subsystem 1502 is shown schematically as a single bus, alternative aspects of the bus subsystem may utilize multiple buses. Bus subsystem 1502 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 1504 controls the operation of computer system 1500 and may comprise one or more processors, application specific integrated circuits (ASICs), or field programmable gate arrays (FPGAs). The processors may be single core or multicore processors. The processing resources of computer system 1500 can be organized into one or more processing units 1532, 1534, etc. A processing unit may include one or more processors, one or more cores from the same or different processors, a combination of cores and processors, or other combinations of cores and processors. In some aspects, processing subsystem 1504 can include one or more special purpose co-processors such as graphics processors, digital signal processors (DSPs), or the like. In some aspects, some or all of the processing units of processing subsystem 1504 can be implemented using customized circuits, such as application specific integrated circuits (ASICs), or field programmable gate arrays (FPGAs).

In some aspects, the processing units in processing subsystem 1504 can execute instructions stored in system memory 1510 or on computer readable storage media 1522. In various aspects, the processing units can execute a variety of programs or code instructions and can maintain multiple concurrently executing programs or processes. At any given time, some or all of the program code to be executed can be resident in system memory 1510 and/or on computer-readable storage media 1522 including potentially on one or more storage devices. Through suitable programming, processing subsystem 1504 can provide various functionalities described above. In instances where computer system 1500 is executing one or more virtual machines, one or more processing units may be allocated to each virtual machine.

In certain aspects, a processing acceleration unit 1506 may optionally be provided for performing customized processing or for off-loading some of the processing performed by processing subsystem 1504 so as to accelerate the overall processing performed by computer system 1500.

I/O subsystem 1508 may include devices and mechanisms for inputting information to computer system 1500 and/or for outputting information from or via computer system 1500. In general, use of the term input device is intended to include all possible types of devices and mechanisms for inputting information to computer system 1500. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g.,“blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 1500 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 1518 provides a repository or data store for storing information and data that is used by computer system 1500. Storage subsystem 1518 provides a tangible non-transitory computer-readable storage medium for storing the basic programming and data constructs that provide the functionality of some aspects. Storage subsystem 1518 may store software (e.g., programs, code modules, instructions) that when executed by processing subsystem 1504 provides the functionality described above. The software may be executed by one or more processing units of processing subsystem 1504. Storage subsystem 1518 may also provide a repository for storing data used in accordance with the teachings of this disclosure.

Storage subsystem 1518 may include one or more non-transitory memory devices, including volatile and non-volatile memory devices. As shown in FIG. 15, storage subsystem 1518 includes a system memory 1510 and a computer-readable storage media 1522. System memory 1510 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 1500, such as during start-up, may typically be stored in the ROM. The RAM typically contains data and/or program modules that are presently being operated and executed by processing subsystem 1504. In some implementations, system memory 1510 may include multiple different types of memory, such as static random access memory (SRAM), dynamic random access memory (DRAM), and the like.

By way of example, and not limitation, as depicted in FIG. 15, system memory 1510 may load application programs 1512 that are being executed, which may include various applications such as Web browsers, mid-tier applications, relational database management systems (RDBMS), etc., program data 1514, and an operating system 1516. By way of example, operating system 1516 may include various versions of Microsoft Windows®, Apple Macintosh®, and/or Linux operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 1522 may store programming and data constructs that provide the functionality of some aspects. Computer-readable media 1522 may provide storage of computer-readable instructions, data structures, program modules, and other data for computer system 1500. Software (programs, code modules, instructions) that, when executed by processing subsystem 1504 provides the functionality described above, may be stored in storage subsystem 1518. By way of example, computer-readable storage media 1522 may include non-volatile memory such as a hard disk drive, a magnetic disk drive, an optical disk drive such as a CD ROM, digital video disc (DVD), a Blu-Ray® disk, or other optical media. Computer-readable storage media 1522 may include, but is not limited to, Zip® drives, flash memory cards, universal serial bus (USB) flash drives, secure digital (SD) cards, DVD disks, digital video tape, and the like. Computer-readable storage media 1522 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 1518 may also include a computer-readable storage media reader 1520 that can further be connected to computer-readable storage media 1522. Reader 1520 may receive and be configured to read data from a memory device such as a disk, a flash drive, etc.

In certain aspects, computer system 1500 may support virtualization technologies, including but not limited to virtualization of processing and memory resources. For example, computer system 1500 may provide support for executing one or more virtual machines. In certain aspects, computer system 1500 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 1500. Accordingly, multiple operating systems may potentially be run concurrently by computer system 1500.

Communications subsystem 1524 provides an interface to other computer systems and networks. Communications subsystem 1524 serves as an interface for receiving data from and transmitting data to other systems from computer system 1500. For example, communications subsystem 1524 may enable computer system 1500 to establish a communication channel to one or more client devices via the Internet for receiving and sending information from and to the client devices. For example, the communications subsystem may be used to transmit a response to a user regarding the inquiry for a chatbot.

Communications subsystem 1524 may support both wired and/or wireless communication protocols. For example, in certain aspects, communications subsystem 1524 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 1524 can provide wired network connectivity (e.g., Ethernet) in addition to or instead of a wireless interface.

Communications subsystem 1524 can receive and transmit data in various forms. For example, in some aspects, in addition to other forms, communications subsystem 1524 may receive input communications in the form of structured and/or unstructured data feeds 1526, event streams 1528, event updates 1530, and the like. For example, communications subsystem 1524 may be configured to receive (or send) data feeds 1526 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 1524 may be configured to receive data in the form of continuous data streams, which may include event streams 1528 of real-time events and/or event updates 1530, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1524 may also be configured to communicate data from computer system 1500 to other computer systems or networks. The data may be communicated in various different forms such as structured and/or unstructured data feeds 1526, event streams 1528, event updates 1530, and the like to one or more databases that may be in communication with one or more streaming data source computers coupled to computer system 1500.

Computer system 1500 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 1500 depicted in FIG. 15 is intended only as a specific example. Many other configurations having more or fewer components than the system depicted in FIG. 15 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A computer-implemented method comprising:
managing a read-optimized database service that provides access to data of a plurality of underlying database structures from one or more underlying database services;
providing access, via the read-optimized database service, to a plurality of functional areas, wherein each functional area provides access to a logical set of resources defined by a logical schema, and wherein each logical resource of the logical set of resources is determined based at least in part on a read-optimized, synchronized version of one or more underlying database structures of the plurality of underlying database structures; wherein the logical schema is different than a database schema of the plurality of underlying database structures;
receiving a request to read data, wherein the request is associated with a consumer of a particular functional area of the plurality of functional areas and references one or more logical resources;
evaluating the request against a particular logical set of resources associated with the particular functional area without providing access to one or more other logical sets of resources associated with one or more other functional areas, wherein evaluating the request comprises executing the request against a particular read-optimized, synchronized version of one or more particular underlying database structures on which the particular logical set of resources is based; wherein executing the request includes executing a join operation not specified in the request as received;
providing a structured result set to the consumer based at least in part on the particular read-optimized, synchronized version of the one or more particular underlying database structures, wherein the structured result set references the one or more logical resources of the particular logical set of resources associated with the particular functional area.

2. The computer-implemented method of claim 1, wherein the structured result set is provided as a JSON object.

3. The computer-implemented method of claim 1, wherein the consumer prompts a large language model based at least in part on the logical schema; wherein the large language model generates the request based at least in part on the logical schema.

4. The computer-implemented method of claim 1, further comprising vectorizing content of the particular logical set of resources using an embedding model specific to the particular logical set of resources; wherein the structured result set is based at least in part on the vectorized content.

5. The computer-implemented method of claim 1, further comprising, responsive to the request, determining one or more particular data items that include one or more missing values as of when the request was received; wherein the one or more particular data items are of a particular type of data item;
accessing a user-specific setting for the particular type of data item to determine that the particular type of data item is to have the missing values predicted by a machine learning model;
based at least in part on the user-specific setting, replacing at least one of the one or more missing values with a particular predicted value determined from the machine learning model;
returning the one or more particular data items as part of the structured result set as if the particular predicted value was part of the one or more particular data items when the request was received.

6. A computer-implemented method comprising:
managing a read-optimized database service that provides access to data of a plurality of underlying database structures from one or more underlying database services;
providing access, via the read-optimized database service, to a plurality of functionally oriented pre-built metadata-based logical objects, wherein the read-optimized database service provides access to a set of resources defined by a logical schema relevant to a functional area, and wherein each logical schema is determined based at least in part on a read-optimized, synchronized version of one or more underlying related database structures on a read optimized database, with the logical schema being different than the database schema of the underlying database structures;
receiving a request to read data, wherein the request is associated with a consumer of a particular functional area of the plurality of functionally oriented metadata-based logical objects and references one or more logical objects;
evaluating the request against a particular logical set of objects associated with the particular functional area, wherein evaluating the request comprises executing the request against a particular read-optimized, synchronized version of one or more particular underlying database structures on which the particular logical set of objects are based; wherein executing the request includes executing one or more join or filter operations not specified in the request as received;
providing a structured result set to the consumer based at least in part on the particular read-optimized, synchronized version of the one or more particular underlying database structures, wherein the structured result set references the one or more logical objects associated with the particular functional area.

7. The computer-implemented method of claim 6, wherein the structured result set is provided as a JSON object.

8. The computer-implemented method of claim 6, wherein the consumer prompts a large language model based at least in part on the logical schema; wherein the large language model generates the request based at least in part on the logical schema.

9. The computer-implemented method of claim 6, further comprising vectorizing content of the particular logical set of objects using an embedding model specific to the particular logical set of objects; wherein the structured result set is based at least in part on the vectorized content.

10. The computer-implemented method of claim 6, further comprising, responsive to the request, determining one or more particular data items that include one or more missing values as of when the request was received; wherein the one or more particular data items are of a particular type of data item;
accessing a user-specific setting for the particular type of data item to determine that the particular type of data item is to have the missing values predicted by a machine learning model;
based at least in part on the user-specific setting, replacing at least one of the one or more missing values with a particular predicted value determined from the machine learning model;
returning the one or more particular data items as part of the structured result set as if the particular predicted value was part of the one or more particular data items when the request was received.

11. A computer-program product comprising one or more non-transitory machine-readable storage media, including stored instructions configured to cause a computing system to perform a set of actions including:
managing a read-optimized database service that synchronizes a plurality of underlying database structures from one or more underlying database services;
providing access, via the read-optimized database service, to a plurality of functional areas, wherein each functional area provides access to a logical set of resources defined by a logical schema, and wherein each logical resource of the logical set of resources is determined based at least in part on a read-optimized, synchronized version of one or more underlying database structures of the plurality of underlying database structures; wherein the logical schema is different than a database schema of the plurality of underlying database structures;
receiving a request to read data, wherein the request is associated with a consumer of a particular functional area of the plurality of functional areas and references one or more logical resources;
evaluating the request against a particular logical set of resources associated with the particular functional area without providing access to one or more other logical sets of resources associated with one or more other functional areas, wherein evaluating the request comprises executing the request against a particular read-optimized, synchronized version of one or more particular underlying database structures on which the particular logical set of resources is based; wherein executing the request includes executing a join operation not specified in the request as received;
providing a structured result set to the consumer based at least in part on the particular read-optimized, synchronized version of the one or more particular underlying database structures, wherein the structured result set references the one or more logical resources of the particular logical set of resources associated with the particular functional area.

12. The computer-program product of claim 11, wherein the structured result set is provided as a JSON object.

13. The computer-program product of claim 11, wherein the set of actions further include prompting, by a consumer, a large language model based at least in part on the logical schema; wherein the large language model generates the request based at least in part on the logical schema.

14. The computer-program product of claim 11, wherein the set of actions further include vectorizing content of the particular logical set of resources using an embedding model specific to the particular logical set of resources; wherein the structured result set is based at least in part on the vectorized content.

15. The computer-program product of claim 11, wherein the set of actions further include, responsive to the request, determining one or more particular data items that include one or more missing values as of when the request was received; wherein the one or more particular data items are of a particular type of data item;
accessing a user-specific setting for the particular type of data item to determine that the particular type of data item is to have the missing values predicted by a machine learning model;
based at least in part on the user-specific setting, replacing at least one of the one or more missing values with a particular predicted value determined from the machine learning model;
returning the one or more particular data items as part of the structured result set as if the particular predicted value was part of the one or more particular data items when the request was received.

16. A system comprising:
one or more processors;
one or more non-transitory computer-readable media storing instructions, which, when executed by the system, cause the system to perform a set of actions including:
managing a read-optimized database service that synchronizes a plurality of underlying database structures from one or more underlying database services;
providing access, via the read-optimized database service, to a plurality of functional areas, wherein each functional area provides access to a logical set of resources defined by a logical schema, and wherein each logical resource of the logical set of resources is determined based at least in part on a read-optimized, synchronized version of one or more underlying database structures of the plurality of underlying database structures; wherein the logical schema is different than a database schema of the plurality of underlying database structures;
receiving a request to read data, wherein the request is associated with a consumer of a particular functional area of the plurality of functional areas and references one or more logical resources;
evaluating the request against a particular logical set of resources associated with the particular functional area without providing access to one or more other logical sets of resources associated with one or more other functional areas, wherein evaluating the request comprises executing the request against a particular read-optimized, synchronized version of one or more particular underlying database structures on which the particular logical set of resources is based; wherein executing the request includes executing a join operation not specified in the request as received;
providing a structured result set to the consumer based at least in part on the particular read-optimized, synchronized version of the one or more particular underlying database structures, wherein the structured result set references the one or more logical resources of the particular logical set of resources associated with the particular functional area.

17. The system of claim 16, wherein the structured result set is provided as a JSON object.

18. The system of claim 16, wherein the set of actions further include prompting, by a consumer, a large language model based at least in part on the logical schema; wherein the large language model generates the request based at least in part on the logical schema.

19. The system of claim 16, wherein the set of actions further include vectorizing content of the particular logical set of resources using an embedding model specific to the particular logical set of resources; wherein the structured result set is based at least in part on the vectorized content.

20. The system of claim 16, wherein the set of actions further include, responsive to the request, determining one or more particular data items that include one or more missing values as of when the request was received; wherein the one or more particular data items are of a particular type of data item;
accessing a user-specific setting for the particular type of data item to determine that the particular type of data item is to have the missing values predicted by a machine learning model;
based at least in part on the user-specific setting, replacing at least one of the one or more missing values with a particular predicted value determined from the machine learning model;
returning the one or more particular data items as part of the structured result set as if the particular predicted value was part of the one or more particular data items when the request was received.

21. A computer-implemented method comprising:
causing display of a configuration interface that provides a first option for treating missing values of a particular type of data item and a second option for treating missing values of another particular type of data item;
receiving, via the configuration interface, a user-specific setting for a user that specifies the particular type of data item and not the other particular type of data item is to have the missing values predicted by a machine learning model;
training the machine learning model to predict values for at least one field of the particular type of data item, wherein the machine learning model is trained on a plurality of historical instances of the particular type of data item where a value for the at least one field is not missing;
receiving a request to retrieve data for the user;
responsive to the request, determining a result including one or more particular data items that include one or more missing values, wherein the one or more particular data items are of the particular type of data item;
based at least in part on the user-specific setting, replacing at least one of the one or more missing values with a particular predicted value determined from the machine learning model;
returning the one or more particular data items as if the particular predicted value was part of the one or more particular data items when the request was received, without updating the one or more particular data items as stored in an underlying database.
